(19) United States
(12) Patent Application Publication
(10) Pub. No.: US 2010/0321202 A1
(43) Pub. Date: Dec. 23, 2010

(54) BATHING UNIT CONTROL SYSTEM PROVIDING MULTIMEDIA FUNCTIONALITY, TELEPHONE FUNCTIONALITY AND/OR DATA NETWORK ACCESS FUNCTIONALITY AND BATHING UNIT SYSTEM INCLUDING SAME

(76) Inventors: Benoit Laflamme, Quebec (CA); Michel Bégin, St-Augustin (CA); Christian Brochu, Quebec (CA)

Correspondence Address: SMART & BIGGAR, 1000 DE LA GAUCHETIERE ST. W., SUITE 3300, MONTREAL, QC, H3B 4W5, CA

(21) Appl. No.: 12/528,277

(22) PCT Filed: Feb. 25, 2008
(86) PCT No.: PCT/CA2008/000353

§ 371 Date: Aug. 21, 2009

Related U.S. Application Data
(60) Provisional application No. 60/891,637, filed on Feb. 26, 2007.
(60) Provisional application No. 60/892,051, filed on Feb. 28, 2007.

(30) Foreign Application Priority Data
Feb. 28, 2007 (CA) 2,579,949

(51) Int. Cl. G08C 17/02; G06F 13/42; G06F 15/16; G06F 13/00; G06F 13/38

(52) U.S. Cl. 340/825.69; 710/106; 709/227; 710/303; 710/63

(57) ABSTRACT

A bathing unit control system suitable for controlling a set of bathing unit components in a bathing unit system and having multimedia control functionality is provided. The bathing unit control system includes a bathing unit controller suitable for issuing signals for controlling the set of bathing unit components in the bathing unit system. The control system also includes a multimedia source interface in communication with the bathing unit controller, the multimedia source interface enabling access to media content associated with an external media source. The control system also includes a control interface in communication with the bathing unit controller the control interface is operative for enabling a user to enter information indicative of a desired change in a certain operational setting of the bathing unit and for enabling a user to enter a media control command to cause media content associated with the external media source to be conveyed to the user. Variants of the control system provide a multimedia source interface adapted for enabling access to a telephone network and a data network such as the Internet.

### FIELD OF THE INVENTION

The present invention relates to the field of control systems for bathing units, and more specifically, to bathing unit control systems providing multimedia functionality, telephone functionality and/or data network access functionality to the users of the bathing units.

### BACKGROUND

A bathing unit, such as a spa, typically includes various components used in the operation of the bathing unit system such as a water holding receptacle, pumps to circulate water in a piping system, a heating module to heat the water, a filter system, an air blower, an ozone generator, a lighting system, and a control system for activating and managing the various parameters of the bathing unit components. Other types of bathing units having similar components include, for instance, whirlpools, hot tubs, bathtubs, therapeutic baths, and swimming pools.

In addition to bathing unit components used in the regulation of the operation of the bathing unit system, features providing added entertainment value and increasingly being included as part of bathing unit systems. An example of such a feature includes lighting elements for providing visual stimulation to the users of the bathing unit system. An example of a lighting element using multicolor LEDs was described in U.S. Pat. No. 6,744,223 entitled “Multicolor lamp system” issued on Jun. 1, 2004 to B. Laflamme et al. The contents of the above document are incorporated herein by reference. Other features include multimedia elements providing audio and/or video functionality. Examples of audio systems for spas have been described in U.S. patent publication no.: US 2002/0025050 A1, entitled “Spa Audio System Operable With A Remote Control” filed on May 24, 2001 by S. S. Macey and in U.S. patent publication no.: 2004/0047484 A1, entitled “Sound system, a speaker assembly, and a method for providing sound for a spa” filed on Sep. 5, 2003 by W. J. Gardenier et al. The contents of the above noted documents are incorporated herein by reference.

Multimedia systems that can be used in a bathing unit system are typically provided with a dedicated media control keypad. Such a media control keypad generally includes a display and user controls. The media control keypad directly connected to the multimedia unit such as an AM/FM/CD player unit to enable the user to control the functionality of the unit.

A deficiency with existing multimedia elements for bathing units is that they do not provide suitable functionality for allowing the user of the spa to conveniently control or interact with the multimedia components from the comfort of the bathing unit and typically require a user to exit the bathing receptacle to control the multimedia components.

In addition, existing bathing unit systems do not provide suitable functionality for allowing the user of the spa to conveniently access the telephone network or a data network such as the Internet from the comfort of the bathing unit.

Against the background described above, it appears that there is a need in the industry to provide a bathing unit control system providing multimedia functionality, telephone functionality and/or data network access functionality that alleviates at least in part the problems associated with existing systems.

### SUMMARY

In accordance with a broad aspect, the invention provides a control system suitable for controlling a set of bathing unit components in a bathing unit system, the set of bathing unit components including a heating module. The control system comprises a bathing unit controller suitable for issuing signals for controlling the set of bathing unit components in the bathing unit system. The control system also comprises a multimedia source interface in communication with the bathing unit controller. The multimedia source interface enables access to media content associated with an external media source. The control system also includes a control interface in communication with the bathing unit controller. The control interface is operative for enabling a user to enter information indicative of a desired change in a certain operational setting of the bathing unit and for enabling a user to enter a media control command to cause media content associated with the external media source to be conveyed to the user.

Advantageously, the control system allows a user to access from a same interface the control of operational settings of the bathing unit and the control of media content associated with the external media source.

In accordance with a specific example of implementation, the control interface includes a display unit adapted for displaying a listing of media elements stored on the external media source. The listing of media elements stored on the external media source may include entries such as, for example, audio album titles, song titles, artist names, movie titles and written media identifiers. The control interface enables a user to enter information for selecting a media element from the listing of media elements and for causing media content associated to the selected media element to be conveyed to a user of the bathing unit system.

In accordance with a specific example of implementation, the multimedia source interface includes a connector interface for exchanging signals with the external media source. The connector interface may include a connector of any suitable configuration adapted for coupling to a complementary connector associated with the external media source. Such a connector interface may include, for example, a serial interface connector, a parallel interface connector and may be a wired interface or a wireless interface. In a non-limiting example of implementation, the connector interface includes a USB connector interface. USB (universal serial bus) is a standard for high speed plug-and-play serial connections between computers and external peripheral devices (such as disk drives, memory sticks, keyboards, mice, digital cameras, scanners, network devices and printers) as well as among other electronic products.

Advantageously, this specific implementation allows the connector interface of the multimedia source interface to be coupled with an external media source embodied in a UFD (USB Flash Drive). In other specific examples of implementation, the multimedia source interface includes a connector interface suitable for exchanging signals with an external media source, where the external media source may be, for example a CD-drive, a CD changer, a DVD-drive, a radio source (traditional AM/FM or satellite), an external audio system, a computer hard drive, an MP3 player, an MPEG player and an MP4 player or any other type of device storing audio, video and/or electronic written media (e.g. newspaper, journals, bathing unit owner's manual) media content.

In accordance with a specific example of implementation, the multimedia source interface includes a media processing unit adapted for accessing media content stored on the external media source over the interface connector. The media processing unit processes the media content to generate a media signal suitable for causing an output module to convey at least part of the media content associated with the external media source to a user. In such an implementation, the multimedia source interface includes an output interface for releasing the media signal for transmittal to the output module. The media processing unit includes modules providing the required functionality for generating the media signal. The functionality to include in embodiments of the media processing unit will depend upon the type of media content that it is desirable to access and convey to the user. For example, where the media content associated with the external media include MP3 audio files, the implementation of the media processing unit would include MP3 player functionality for generating an audio media signal. Similarly, where the media content associated with the external media include MP4 video files, the implementation of the media processing unit would include MP4 player functionality for generating a video media signal. Where the media content associated with the external media includes electronic written media (e.g. newspaper, journals, bathing unit owner's manual) in a certain format (such as a “.pdf” file for example), functionality for generating display media signal on the basis of the electronic written media (such as a “.pdf” reader for example) would be implemented in the media processing unit.

In accordance with an alternative example of implementation, the multimedia source interface is adapted for exchanging signals with a set of external media sources. The set of external media sources includes at least two external media sources where each external media source stores respective media content. The external media sources in the set of external media sources may be of a same type or of different types. In either case, the multimedia source interface will include a plurality of connector interfaces configured for exchanging signals with the external media sources. Where the external media sources are of different types, the multimedia source interface comprises connector interfaces adapted for exchanging signals with a respective type of external media source.

In accordance with another broad aspect, the invention provides an apparatus for providing multimedia functionality for use in connection with a bathing unit system. The apparatus implements a multimedia source interface comprising an interface connector adapted for establishing a communication link with an external media source for accessing media content stored on the external media source. The multimedia source interface also comprises a communication entity operative for exchanging signals with a bathing unit controller, the communication entity being operative for receiving signals conveying media control commands from the bathing unit controller. The multimedia source interface also comprises a processing unit in communication with the interface connector and the communication entity. In use the processing unit is responsive to media control commands received from the bathing unit controller for causing a media signal to be generated, the media signal conveying at least part of the media content stored on the external media source. The multimedia source interface also includes an output interface in communication with the processing unit. The output interface is operative for releasing the media signal in a format suitable for causing an output module to convey at least part of the media content associated with the external media source to a user.

In accordance with a specific example of implementation, the certain media control command is a first media control command. In response to signals conveying a second media control command the processing unit is operative for accessing information associated to media content stored on the external media source and for causing a signal conveying the information associated to media content stored on the external media source to be transmitted to the bathing unit controller through the communication entity.

In accordance with a specific example of implementation, the output interface of the apparatus includes one or more ports suitable for establishing connections, either through wireless or wired connections, with desired output modules including without being limited to, video display modules and audio output modules. In accordance with a specific example of implementation, the output interface of the apparatus includes a wireless port suitable for establishing a connection with a wireless speaker module or wireless headset. The connection with the wireless speaker module or wireless headset may be made using any suitable wireless protocol. In a specific practical implementation, a short-range wireless protocol, such as the BLUETOOTH protocol, is used for effecting the connection between the output interface and the wireless speaker module or wireless headset. Other suitable types of wireless communication protocols may also be used without detracting from the spirit of the invention.

In accordance with another broad aspect, the invention provides an apparatus for providing multimedia functionality for use in connection with a bathing unit system. The apparatus comprises a body defining a cavity suitable for receiving therein an external media source storing media content. The apparatus also includes an interface connector positioned within the cavity defined by the body of the apparatus and suitable for coupling with a complementary connector associated with an external media source for accessing media content stored on the external media source. The apparatus also includes a communication entity operative for exchanging signals with a bathing unit controller and a processing unit in communication with the interface connector and the communication entity. In use the processing unit is responsive to media control commands received from the bathing unit controller for causing a media signal to be generated, the media signal conveying at least part of the media content stored on the external media source. The apparatus also includes an output interface in communication with the processing unit. The output interface is for releasing the media signal in a format suitable for causing an output module to convey at least part of the media content associated with the external media source to a user.

In a specific example of implementation, the body of the apparatus is suitable for being positioned on an outside panel of a bathing unit. In a non-limiting implementation, for the installation of the apparatus, a recess is created on the outside panel of the bathing unit for receiving therein the body of the apparatus.

In a specific example of implementation, the apparatus comprises a cover member suitable for engaging the body such as to substantially enclose the cavity defined by the body. The cover member may be a component that can be separated from the body during normal use or may be a component that is moveably connected to the body. In a specific implementation, the cover member is hingedly connected to the body and is movable between a first position in which it substantially encloses the cavity defined by the body and a second position in which it allows access to the cavity defined by the body. In a specific implementation, the cover member will be suitable for engaging the body such as to substantially prevent water from entering the cavity during use of the bathing unit system.

In a specific example of implementation, the apparatus comprises a set of interface connectors positioned within the cavity defined by the body of the apparatus, the set of connectors including at least two connectors. The interface connectors in the set of interface connectors are suitable for engaging respective complementary connectors associated with external media sources. In a specific implementation, the set of connectors includes at least two connectors that are suitable for coupling with different types of complementary connectors associated with external media sources.

In accordance with another broad aspect, the invention provides a control system suitable for controlling a set of bathing unit components in a bathing unit system, the set of bathing unit components including a heating module. The control system comprises a bathing unit controller suitable for issuing signals for controlling the set of bathing unit components in the bathing unit system. The control system also comprises a multimedia source interface in communication with the bathing unit controller. The multimedia source interface enables access to media content associated with an external media source and includes an output interface for releasing signals suitable for causing an output module to convey at least part of the media content associated with the external media source to a user. The control system also comprises a media control interface in communication with the bathing unit controller. The media control interface is operative for enabling a user to enter a first media control command to obtain information associated to media content associated with the external media source. The media control interface also enables the user to enter a second media control command for causing the output module to convey at least part of the media content associated with the external media source to a user.

In accordance with a specific example of implementation, the output interface of the multimedia source interface includes a wireless port suitable for establishing a connection with a wireless speaker module or wireless headset. The connection with the wireless speaker module or wireless headset may be made using any suitable wireless protocol. In a specific practical implementation, a short-range wireless protocol, such as the BLUETOOTH protocol, is used for effecting the connection between the output interface and the wireless speaker module or wireless headset. Other suitable types of wireless communication protocols may also be used without detracting from the spirit of the invention.

In accordance with another broad aspect, the invention provides a control system suitable for controlling a set of bathing unit components in a bathing unit system, the set of bathing unit components including a heating module. The control system comprises a bathing unit controller suitable for issuing signals for controlling the set of bathing unit components in the bathing unit system. The control system also comprises a multimedia source interface in communication with the bathing unit controller, the multimedia source interface enabling access to a telephone network. The control system also includes a telephone control interface in communication with the bathing unit controller. The telephone control interface is operative for enabling a user within the bathing unit system to access the telephone network by sending a telephone control command to the multimedia source interface through the bathing unit controller.

In accordance with a specific example of implementation, the telephone control interface forms and integral part of a bathing unit control interface, where the bathing control interface is operative for enabling a user to enter information indicative of a desired change in a certain operational setting of the bathing unit system. Advantageously, this specific implementation allows a user to control from a same interface the operational settings of the bathing unit and the access to a telephone network.

In accordance with another broad aspect, the invention provides a control system suitable for controlling a set of bathing unit components in a bathing unit system, the set of bathing unit components including a heating module. The control system comprises a bathing unit controller suitable for issuing signals for controlling the set of bathing unit components in the bathing unit system. The control system also comprises a multimedia source interface in communication with the bathing unit controller, the multimedia source interface enabling access to a data network. The control system also comprises a browser control interface in communication with the bathing unit controller. The browser control interface is operative for enabling a user to access the data network by sending a data network control command to the multimedia source interface through the bathing unit controller.

In accordance with a specific example of implementation, the browser control interface forms part of a bathing unit control interface, the bathing control interface being operative for enabling a user to enter information indicative of a desired change in a certain operational setting of the bathing unit system. Advantageously, this specific example of implementation allows a user to control from a same interface the operational settings of the bathing unit and the access to a data network.

In accordance with yet another broad aspect, the invention provides a control system suitable for controlling a set of bathing unit components in a bathing unit system, the set of bathing unit components including a heating module. The control system comprises a bathing unit controller suitable for issuing signals for controlling the set of bathing unit components in the bathing unit system. The control system also comprises a multimedia source interface in communication with the bathing unit controller, the multimedia source interface enabling access to media content associated with an external media source. The control system also includes a bathing unit control interface and a media control interface distinct from the bathing unit control interface. The bathing unit control interface is in communication with the bathing unit controller and enables a user to enter information indicative of a desired change in a certain operational setting of the bathing unit. The media control interface is also in communication with the bathing unit controller and enables a user to enter a media control command to cause media content associated with the external media source to be conveyed to the user.

In accordance with yet another broad aspect, the invention provides a control system suitable for controlling a set of bathing unit components in a bathing unit system, the set of bathing unit components including a heating module. The control system comprises a bathing unit controller suitable for issuing signals for controlling the set of bathing unit components in the bathing unit system. The control system also comprises a multimedia source interface in communication with the bathing unit controller, the multimedia source interface is for enabling access to media content associated with an external media source and for enabling access to a telephone network. The control system also includes a control interface in communication with the bathing unit controller, the control interface implements a media control interface for enabling a user to enter a media control command to cause media content associated with the external media source to be conveyed to the user. The control interface also implements a telephone control interface for enabling a user to initiate a telephone function by sending a telephone control command to the multimedia source interface through the bathing unit controller.

In accordance with a specific example of implementation, the multimedia source interface is further operative for enabling access to a data network and the control interface implements a browser control interface for enabling a user to access the data network.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 shows a block diagram of a bathing unit system equipped with a bathing unit control system in accordance with a specific example of implementation of the present invention;

FIGS. 2a and 2b show block diagrams of bathing unit control systems providing multimedia functionality in accordance with specific examples of implementation of the present invention;

FIG. 2c shows a specific practical implementation of a bathing unit control system providing multimedia functionality in accordance with a specific example of implementation of the present invention;

FIG. 3 shows a functional block diagram of a multimedia source interface suitable for use in the bathing unit control system depicted in FIG. 2a in accordance with a specific example of implementation of the present invention;

FIG. 4 shows a functional block diagram of a multimedia source interface in accordance with an alternative specific example of implementation of the present invention;

FIG. 5 shows a first specific practical implementation of a multimedia source interface in accordance with an example of implementation of the present invention;

FIG. 6 shows a functional block diagram of the multimedia source interface shown in FIG. 5 in accordance with an example of implementation of the present invention;

FIGS. 7a and 7b show a second specific practical implementation of a multimedia source interface in accordance with another example of implementation of the present invention;

FIG. 8 shows the second specific practical implementation of the multimedia source interface depicted in FIGS. 7a and 7b positioned on an outside panel of a bathing unit receptacle in accordance with a specific example of implementation of the present invention;

FIG. 9 shows a practical implementation of a bathing unit system equipped with a bathing unit control system providing multimedia functionality in accordance with a specific non-limiting example of implementation of the present invention;

FIG. 10 shows a functional block diagram of a bathing unit control system providing telephone network access functionality in accordance with a specific non-limiting example of implementation of the present invention;

FIG. 11 shows a functional block diagram of a bathing unit control system providing computer network access functionality in accordance with a specific non-limiting example of implementation of the present invention.

FIGS. 12a, 12b and 12c show a specific practical implementation of a control interface suitable for use with the bathing unit control system depicted in FIG. 2a in accordance with a non-limiting example of implementation of the present invention;

FIG. 13 shows a specific practical implementation of a control interface including an integrated multimedia source interface in accordance with an alternative example of implementation of the present invention.

FIG. 14 is a block diagram of an apparatus for implementation of a multimedia source interface in accordance with another example of implementation of the present invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The description below is directed to a specific implementation of the invention in the context of a bathing unit system. It is to be understood that the term “bathing unit system”, as used for the purposes of the present description, refers to spas, whirlpools, hot tubs, bathtubs, therapeutic baths, swimming pools and any other type of bathing unit that can be equipped with a control system for controlling various operational settings and for providing multimedia functionality, telephone functionality and/or data network access functionality to the users of the bathing units.

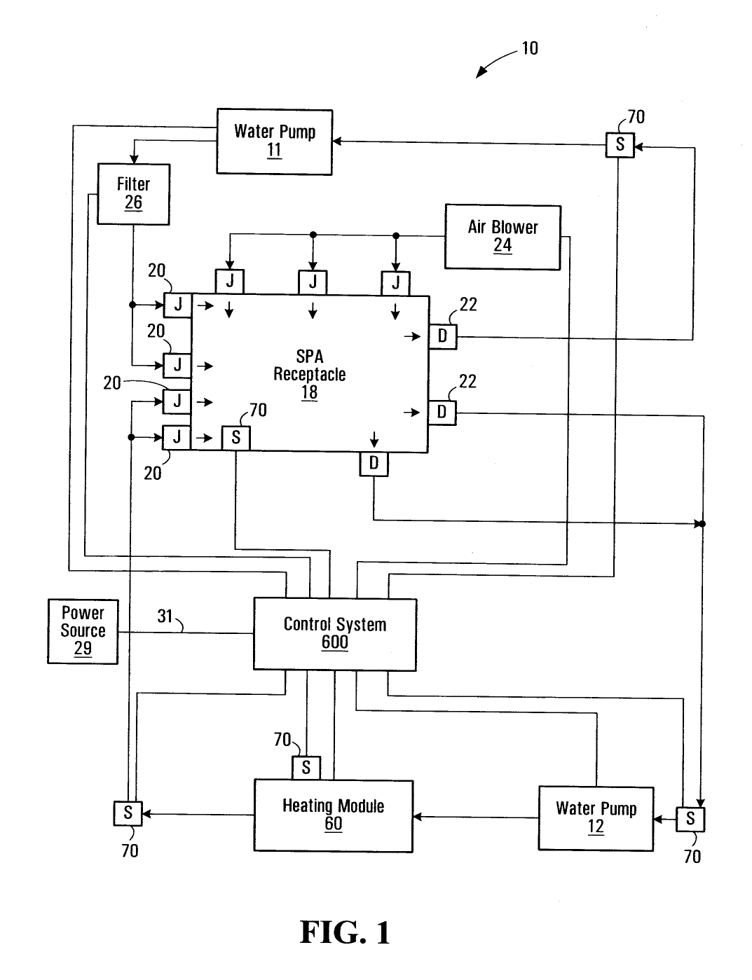

FIG. 1 illustrates a block diagram of a bathing unit system 10 in accordance with a specific example of implementation. The bathing unit system 10 includes a bathing unit receptacle 18 for holding water, a plurality of jets 20, a set of drains 22, a heating module 60, two water pumps 11 & 12, a filter 26 and an air blower 24, and a control system 600. It should be understood that the bathing unit system 10 could include more or less bathing unit components without departing from the spirit of the invention.

The control system 600 receives electrical power from an electric power source 29 and controls the distribution of power supplied to the various bathing unit components on the basis of control signals received from various sensors 70 in order to cause the desired operational settings to be implemented. Manners in which the control system 600 can be used to control the bathing unit components for the regulation of the operation of the bathing unit system, such as for example the jets 20, the drains 22, the heating module 60, the water pumps 11 & 12, the filter 26 and the air blower 24, are well known in the art and are not critical to the invention and as such will not be described in further detail here.

The control system 600, in addition to controlling the bathing unit components used in the regulation of the operation of the bathing unit system, provides multimedia functionality, telephone functionality and/or data network access functionality to the users of the bathing unit system 10.

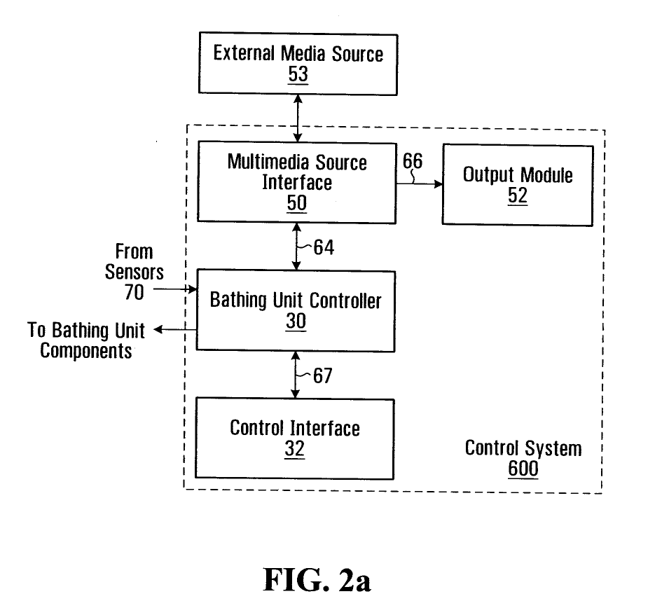

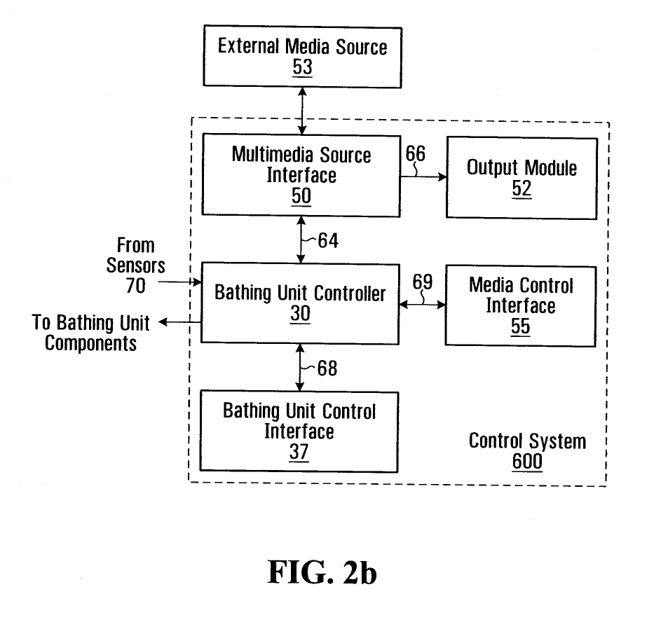

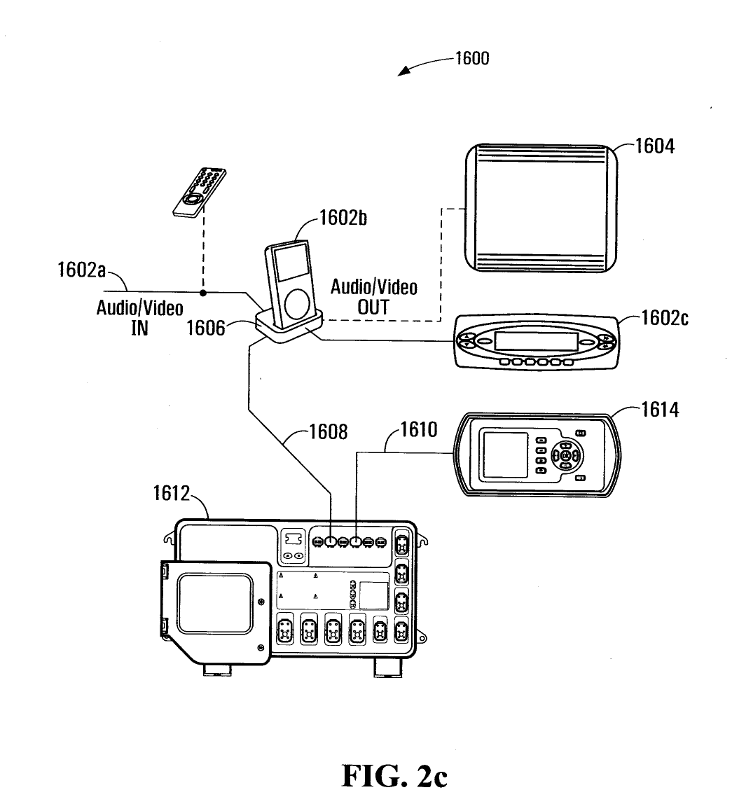

A specific example of implementation of the control system 600 is depicted in FIG. 2a of the drawings. The embodiment depicted in FIG. 2a shows a specific implementation of the control system 600 providing multimedia functionality. Embodiments of the control system 600 implementing telephone functionality and/or data network access functionality will be described later on in the specification as variants of the control system 600 providing multimedia functionality shown in FIG. 2a. For the purpose of simplicity, the sensors 70 used for monitoring the operation of the bathing unit components shown in FIG. 1 have been omitted from the illustration of FIG. 2a.

As shown, the control system 600 includes a control interface 32, a bathing unit controller 30 and a multimedia source interface 50 in communication with a multimedia output module 52. The bathing unit controller 30 issues signals for controlling the set of bathing unit components in bathing unit system 10 (shown in FIG. 1) either on the basis of control signals received from various sensors 70 or on the basis of user commands provided through control interface 32. The multimedia source interface 50 communicates with the bathing unit controller 30 over communication link 64 and provides access to media content associated with an external media source 53. The external media source 53 may be embodied as any number of suitable media carrier as will be illustrated later on in the present application. The control interface 32 communicates with the bathing unit controller 30 over communication link 67 and enables a user to enter information indicative of a desired change in a certain operational setting of the bathing unit system. Some non-limiting examples of operational settings of the bathing unit system include temperature control settings, jet control settings and lighting settings, amongst others. The control interface 32 also provides the user with multimedia control functionality. For example, the control interface 32 enables a user to enter a media control command to obtain information associated to media content associated with the external media source 53. The control interface 32 also enables a user to cause media content associated with the external media source 53 to be conveyed to a user through the multimedia output module 52.

Advantageously, the embodiment depicted in FIG. 2a enables a user of the bathing unit system to control the operational settings of the bathing unit and to access media content on the external media source 53 from a same interface, namely control interface 32.

It will be appreciated that, although the multimedia output module 52 is depicted as being connected to the multimedia source interface 50, the multimedia output module 52 may be connected to the external media source 53, the bathing unit controller 30 or the control interface 32 in alternative embodiments of the invention. Alternatively still, the output module 52 may be an integral part of the control interface 32. For example, the control interface 32 may include one or more output modules 52 embodied as audio speakers and/or display screens for conveying to the user audio and/or video media content associated with the external media source 53. In such an embodiment, media signals conveying the audio and/or video media content associated with the external media source 53 are transmitted to the control interface 32 by the multimedia source interface 50 through the bathing unit controller 30. These signals are adapted for causing audio and/or video media content to be conveyed to a user of the bathing unit system through the display and/or the audio speakers of the control interface 32.

As can be seen from FIGS. 1 and 2a, the components of the control system 600 are interconnected through a central link namely the bathing unit controller 30. More specifically, the bathing unit components of the bathing unit system 10 are in communication with the control interface 32 through bathing unit controller 30. Similarly, the communication path between the multimedia source interface 50 and the control interface 32 goes through the bathing unit controller 30. Advantageously, this configuration allows for a single communication link 67 between the bathing unit controller 30 and the control interface 32 to carry both control signals pertaining to the regulation of the operation of the bathing unit system and signals pertaining to multimedia functionality. In embodiments where the communication link 67 is a wired connection, this facilitates the installation of the control system 600 since a single cable needs to be run from the control interface 32. It will be apparent that the communication link 67 could be comprised of multiple physical electrical lines for carrying various signals between the control interface 32 and the bathing unit controller 30. However, during installation, these multiple physical electrical lines can be run through a same physical path. Where the communication link 67 is a wireless connection, a single wireless transceiver at the control interface 32 can be user to transmit control signals pertaining to the regulation of the operation of the bathing unit system and signals pertaining to multimedia functionality.

In a variant of control system 600, shown in FIG. 2b, the control of the operational setting of the bathing unit system 10 is provided separately from the multimedia control functionality. More specifically, media control functionality is provided to the user of the bathing unit by media control interface 55 and the control of the operational setting of the bathing unit system 10 is provided through bathing unit control interface 37. The media control interface is in communication with bathing unit controller over communication link 69 and bathing unit control interface 37 is in communication with bathing unit controller 30 over communication link 68. Both communication links may be either wired or wireless links.

In yet another variant not shown in the figures, media control functionality is provided to the user of the bathing unit via both a media control interface such as media control interface 55 and a control interface of the type of control interface 32. In this variant, the control of the multimedia functionality is provided by two interfaces namely through a media control interface 55 dedicated to the control multimedia components and through control interface 32 providing control of the operational settings of the bathing unit system and control of multimedia functionality.

In a typical interaction, a user enters a media control command at the control interface 32 (shown in FIG. 2a) or media control interface 55 (shown in FIG. 2b). In a non-limiting example of implementation, the media control command conveys a multimedia function, such as “PLAY”, “STOP”, “PAUSE”, “FAST FORWARD”, “REWIND”, “STEP FORWARD”, “STEP BACK”, “SHUFFLE”, “REPEAT”, “OPEN FILE” or any other suitable type of media function with respect to certain media content on an external media source 53. Alternatively, the media control command conveys a request to obtain a listing of media elements stored on the external media source 53.

The media control command is transmitted from the control interface 32 to the bathing unit controller 30 over communication link 67 or from media control interface 55 to the bathing unit controller 30 over communication link 69. The bathing unit controller 30 receives the media control command and transmits a signal conveying the media control command to the multimedia source interface 50 over communication link 64. The bathing unit controller 30 may perform some processing on the media control command or may transmit this media control command to the multimedia source interface without processing it. The multimedia source interface 50 processes the signal conveying the media control command and causes the functions associated to that media control command to be executed. The manner in which the multimedia source interface 50 causes a command to be executed will become apparent to the person skilled in art in light of the description presented later on in this specification.

A practical non-limiting implementation of a control system 600 is depicted in FIG. 2c of the drawings. As shown, the control system, designated with reference numeral 1600, includes a bathing unit controller 1612, a control interface 1614 and a multimedia source interface 1606. The bathing unit controller 1612 includes a plurality of connectors for interconnecting various bathing unit components. The control interface 1614 and the multimedia source interface 1606 are connected to respective connectors of the bathing unit controller 1612 and communicate with bathing unit controller 1612 over communication links 1610 and 1608 respectively. The multimedia source interface 1606 is embodied as a free standing structure including a set of interface connectors suitable for establishing connections with various external media sources and output modules. A shown, the multimedia source interface 1606 communicates a set of external media sources 1602a-c including a digital audio player 1602b (such as an MP3 player or equivalent audio format) and a radio tuner 1602c. The multimedia source interface 1606 also includes an input for receiving an audio or video signal (labeled as “AUDIO/VIDEO IN” in FIG. 2c) from an external device 1602a. Such an external device may be, for example, a stereo/video system. The multimedia source interface 1606 also communicates with an output module 1604 embodied as a speaker in FIG. 2c. It will be apparent to the person skilled in the art in light of the present specification that several variations of implementation of control system 600 are possible and that the example depicted in FIG. 2c was presented for the purpose of illustration only.

In the embodiments depicted in FIGS. 2a and 2b, the multimedia source interface 50 has been described as a component separate from the bathing unit controller 30 and the control interface 32. It will be appreciate that the multimedia source interface 50 may, in alternative embodiments, form an integral part of the bathing unit controller 30 or may form an integral part of the control interface 32 without detracting from the spirit of the invention. As will be appreciated, in embodiment where the multimedia source interface 50 is part of the bathing unit controller 30, the communication link 64 will be replaced by internal communication channels within the bathing unit controller 30. Similarly, in embodiments where the multimedia source interface 50 is an integral part of the control interface 32, the communication link 64 with the bathing unit controller 30 will be omitted.

### Multimedia Source Interface 50

Embodiments in which the multimedia source interface 50 is a component separate from the bathing unit controller 30 and the control interface 32 will now be described for the purpose of illustration.

In specific practical examples of implementation, the multimedia source interface 50 may be configured to be installed on the top-side of a bathing unit receptacle (so that it can be accessed by a user positioned in the bathing unit receptacle), on an exterior panel of the bathing unit receptacle or in a location remote from the bathing unit receptacle. Where the multimedia source interface 50 is to be located in a location remote from the bathing unit receptacle, it can be mounted on a wall (for example in or outside a house) or it may be integrated in a free standing structure. The multimedia source interface 50 may be in communication with the bathing unit controller 30 over a wireless or wired communication link.

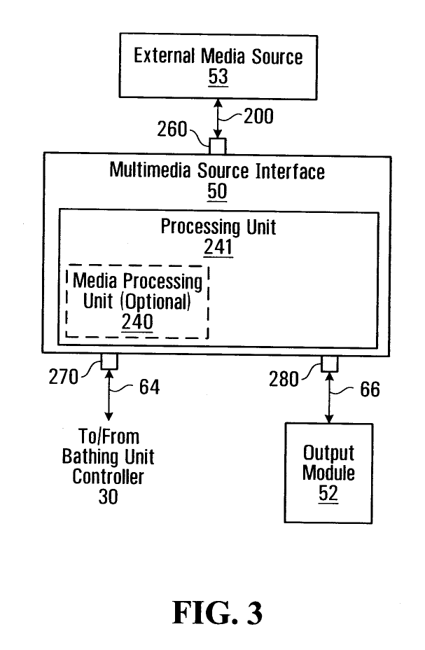

A functional block diagram of a specific example of implementation of multimedia source interface 50 is depicted in FIG. 3 of the drawings.

As depicted, the multimedia source interface 50 includes a connector interface 260 for establishing a communication link 200 with an external media source 53, a port 270 for establishing a communication link 64 with the bathing unit controller 30, an output interface 280 for establishing a communication link 66 with an output module 52 and a processing unit 241.

The port 270 is for receiving signals conveying media control commands from the bathing unit controller 30 over communication link 64 and for transmitting information through the bathing unit controller 30 to the control interface 32 (depicted in FIG. 2a) and/or to the media control interface 55 (depicted in FIG. 2b). The communication link 64 between the multimedia source interface 50 and the bathing unit controller 30 may be embodied in any suitable format for allowing the multimedia source interface 50 and the bathing unit controller 30 to exchange signals. The communication link 64 may be established over a wired connection or a wireless connection. Where the communication link 64 is established over a wireless link, the port 270 includes a wireless transceiver for exchanging messages with a corresponding wireless transceiver associated with the bathing unit controller 30. The wireless link may be for example a radio frequency (RF) link, an infra-red (IR) link or an optical link. Where the communication link 64 is established over a wireless link, the multimedia source interface 50 may be positioned remotely from the bathing unit controller 30 and can be installed for example inside a house or in any suitable location removed from the bathing unit system installation. The output interface 280 is for releasing a media signal in a format suitable for causing an output module 52 to convey at least part of the media content associated with the external media source 53 to a user. In a specific example of implementation, the output interface 280 includes a port for establishing the communication link 66 with the external output module 52. As was the case for communication link 64, the communication link 66 between the multimedia source interface 50 and the output module 62 may be embodied in any suitable format for allowing the multimedia source interface 50 to transmit media signals to output module 62. The communication link 66 may be established over a wired connection or a wireless connection. Where the communication link 64 is established over a wireless link, the output interface 280 includes a wireless port including a wireless transmitter for transmitting signals to a corresponding wireless receiver associated with the output module 52. In a specific example of implementation the output interface 280 includes a wireless port suitable for establishing a connection with an output module 52 embodied as a wireless speaker module or a wireless head-set. The connection with the wireless speaker module or wireless headset may be made using any suitable wireless protocol. In a specific practical implementation, a short-range wireless protocol, such as the BLUETOOTH protocol, will be used for effecting the connection between the output interface and the wireless speaker module or wireless headset. It will however be appreciated that any suitable wireless protocol may be used without detracting from the spirit of the invention. In addition, although the above description illustrates examples of the output module 52 as being embodied as a wireless speaker module or wireless headset, it will be appreciated that the output module 52 may include any suitable wireless or wired device suitable for conveying media content to a user including but not limited to a speaker, a headset and a display module each of which may be of a wireless or a wired configuration.

As a variant, not shown in the figures, the output module 52 is an integral component of the multimedia source interface 50. In such a variant, the output interface 280 may be omitted. In yet another variant, the output interface 280 may be connected directly to the external media source 53. In such a variant the output interface 280 may also be omitted from the multimedia source interface 50.

In yet another variant, not shown in the figures, the output module 52 is connected to the control interface 32 or forms an integral component of the control interface 32. In such a variant the output interface 280 may also be omitted from the multimedia source interface 50 and media signals conveying media content associated with the external media source 53 will be transmitted to the control interface 32 through the bathing unit controller either through port 270 or through a separate output port.

The connector interface 260 is adapted for establishing a communication link 200 with the external media source 53 for accessing media content stored on the external media source 53. The connector interface 260 may include a connector of any suitable configuration adapted for coupling to a complementary connector associated with the external media source with or without the requirement of an adapter there between. Such a connector interface 260 may include, for example, a serial interface connector, a parallel interface connector and may be a wired connector or a wireless connector. In a non-limiting example of implementation, the connector interface 260 includes a USB connector interface. Advantageously, a USB connector interface allows connector interface 260 to be coupled with an external media source embodied in a UFD (USB Flash Drive) which is a common type of storage medium for data files and media files. In other specific examples of implementation, the connector interface 260 is suitable for exchanging signals with an external media source 53, where the external media source 53 may be, for example, a CD-drive, a CD changer, a DVD-drive, a radio source (traditional AM/FM or satellite), a computer hard drive, an MP3 player, an MP4 player or any other type of device storing audio, video and/or electronic written media (e.g. newspaper, journals) media content. The connector interface 260 may also include a connector interface embodied as a computer network connector, a wireless antenna for Internet connection, a television cable connector, a telephone jack and/or a connector suitable for engaging a cellular-phone. In will be appreciated that a connector interface providing access to the Internet would also enable a user to access internet radio stations or any other audio or video source available on the Internet. The Internet connection could also give access to an IP phone connection such as for example SKYPE. Where the external media source 53 is a device implementing media content processing functionality for generating media signals in addition to storing media content, the connector interface 260 is adapted for engaging the control port of the external media source 53 to allow control signals to be transmitted to the external media source 53 from the multimedia source interface. In this embodiment, the connector interface 260 may also be adapted for receiving media signals (for example audio and/or video signals) generated by the external media source 53 in response to the control signals. The audio/video media signal are communicated to the output interface 280 so that audio and/or video signals generated by the external media source 53 can be conveyed to the user by output module 52.

The processing unit 241 is in communication with the interface connector 260, the port 270 and the output interface 280 and provides functional modules for enabling communication between the control interface 32 shown in FIG. 2a or the media control interface 55 shown in FIG. 2b (both through the intermediary of bathing unit controller 30) and the external media source 53. In addition, where the output module 52 is connected to the multimedia source interface 50, the processing unit 241 provides functional modules for enabling communication between the output module 52 and the external media source 53. The functional modules may, for example, implement communication protocols, signal format conversions and any other function required for enabling communication between the different components 30 53 50 and 52. As such, communication paths between the different components 30 53 50 and 52 are created by the multimedia source interface 50. Any suitable methods and techniques known in the art can be used for providing such communication capability without detracting from the spirit of the invention. The specific manner in which the functional modules enable the communication between the various components is not critical to the invention and as such will not be described in further detail here.

The processing unit 241 is responsive to media control commands originating from the control interface 32 (shown in FIG. 2a) and received from the bathing unit controller 30 at the port 270 for causing the functions associated to the media control commands to be executed. The processing unit 241 is responsive to media control commands to cause a media signal to be generated, the media signal conveying at least part of the media content stored on the external media source 53. The processing unit 241 then causes the generated media signal to be released at the output interface 280. The media signal released at the output interface 280 in a format suitable for causing the output module 52 to convey at least part of the media content associated with the external media source 53 to a user. The processing unit 241 is also responsive to media control commands to access information associated to media content stored on the external media source 53 and to cause a signal conveying the information associated to media content stored on the external media source to be transmitted to the bathing unit controller 30 through port 270.

The functions associated to the media control commands may be executed in totality or in part by the processing unit 241, in which case the processing unit 241 will include media content processing functionality, or alternatively may be executed by the external media source 53 on the basis of signals transmitted from the multimedia source interface 50 to the external media source 53. In the latter case, the media content processing functionality will be implemented by the external media source 53.

In a first specific example of implementation, the multimedia source interface 50 transmits a control signal to the external media source 53 for causing the latter to execute the functions associated with media control command. In this first specific example of implementation, the multimedia source interface 50 will typically include suitable format conversion modules for converting the media control command originating from the control interface 32 (or media control interface 55) into a format that is compatible with the external media source 53. The multimedia source interface 50 then transmits the converted media control command to the external media source 53 for execution. Such media control commands may include commands for implementing functions such as “PLAY”, “STOP”, “PAUSE”, “FAST FORWARD”, “REWIND”, “STEP FORWARD”, “STEP BACK”, “SHUFFLE”, “REPEAT”, “OPEN FILE” or any other desirable type of media function with respect to media content. Such media control commands are then executed by the external media source 53 which processes the media content stored on the external media source 53 on the basis of the media control commands to generate a media signal conveying at least part of the media content associated with the external media source. The external media source 53 then transmits the media signal over communication link 200 to the multimedia source interface 50. The multimedia source interface 50 receives the media signal conveying at least part of the media content associated with the external media source and releases at output interface 280 the media signal in a format suitable for causing the output module 52 to convey at least part of the media content associated with the external media source to a user. The multimedia source interface 50 is also adapted for enabling information typically displayed on a control panel associated to an external media source 53 and conveying information as to the media content of the external media source 53 to be transmitted to the control interface 32 for display to the user. In a typical interaction, the multimedia source interface 50 receives signals from the external media source 53 conveying information to be displayed on the control interface 32. The multimedia source interface 50 is adapted for releasing at output interface 270 a signal for causing a display associated with the control interface 32 to convey at least part of the media content associated with the external media source to a user or other suitable type of information typically displayed on a control panel associated to an external media source 53. In a non-limiting example, such a configuration would allow, an external media source 53 embodied as an MP3 player or other similar type of audio device (e.g. iPOD™) or MPEG player to be connected to the multimedia source interface 50 through interface connector 260 and to provide display information of the type typically displayed on such a device at the control interface 32 (shown in FIG. 2a). Such information may include, without being limited to, artist names and/or band names, audio album titles, song titles, movie titles, written media identifiers, file size and timing information. In a specific example of implementation, the media control command originating from the control interface 32 (or media control interface 55) may also convey a request to obtain a listing of media elements stored on the external media source 53. In such cases the multimedia source interface 50 is adapted for receiving a signal conveying the listing of media elements from the external media source 53. The multimedia source interface 50 then generates a signal conveying the listing of media elements and transmits this signal through the bathing unit controller 30 to the control interface 32 shown in FIG. 2a (or media control interface 55 shown in FIG. 2b) for display.

In a second specific example of implementation, the processing unit 241 includes functional modules for locally providing media content processing functionality for executing the functions associated with media control commands originating from the control interface 32 (or media control interface 55). The multimedia source interface 50 may, for example, includes functional modules for accessing media content on the external media source 53 and for implementing functions such as “PLAY”, “STOP”, “PAUSE”, “FAST FORWARD”, “REWIND”, “STEP FORWARD”, “STEP BACK”, “SHUFFLE”, “REPEAT”, “OPEN FILE” or any other desirable type of media function with respect to the media content. In this second specific example of implementation, the processing unit 241 includes a media-processing unit 240, as depicted in FIG. 3, for implementing these functional modules. The media-processing unit 240 processes the media content obtained from the external media source 53 to generate a media signal conveying at least part of that media content to a user. The processing unit 241 then releases that media signal at output interface 280 in a format suitable for output module 52. In a non-limiting examples of implementation, the media-processing unit 240 may include functional modules for implementing MP3 (or other audio format) player functionality, MPEG player functionality, MP4 (or other video format) player functionality, CD player functionality and DVD player functionality amongst others.

In a specific example of implementation, the media content associated with the external media source 53 includes electronic written media in a certain format (such as a “.pdf” file in a non-limiting implementation). In such cases, the media-processing unit 240 may include functionality for generating a display media signal on the basis of an electronic written media (such as a “.pdf” data file for example). In this second specific example of implementation, the multimedia source interface 50 also includes functional modules for accessing a listing of media elements stored on the external media source 53 and for transmitting a signal conveying this listing for display at the control interface 32 (or media control interface 55). In this embodiment, the external media source 53 may conveniently be embodiment as a media carrier medium, such as a USB Flash drive, without imbedded media content processing functionality since such functionality is integrated in the multimedia source interface 50.

Optionally, in variants of implementations, the multimedia source interface 50 includes a built-in radio device (AM/FM and/or Satellite), MP3/MP4/MPEG or equivalent player with local memory storage capabilities, wireless antenna for Internet connection, telephone jack or cordless phone antenna, cell-phone antenna and television cable receiver amongst others.

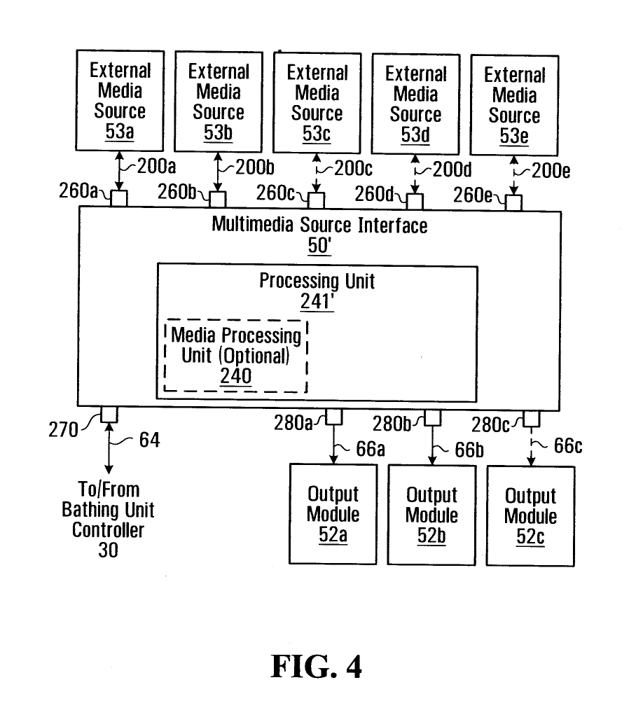

A functional block diagram of a variant of the multimedia source interface 50, designated as multimedia source interface 50′, is depicted in FIG. 4 of the drawings. In this variant, the multimedia source interface 50′ includes set of connector interfaces 260a-e each being analogous to the connector interface 260 described with reference to FIG. 3. The connector interfaces 260a-e are adapted for establishing respective communication links 200a-e with external media sources 53a-e. The multimedia source interface 50′ also includes a port 270 for establishing a communication link 64 with the bathing unit controller 30 and a processing unit 241′. In the variant depicted in FIG. 4, the multimedia source interface 50′ also includes a plurality of output interfaces 280a-c (analogous to output interface 280 described with reference to FIG. 3) for establishing communication links 66a-c with respective output modules 52a-c. It will be appreciated that other embodiments of the multimedia source interface 50′ may include multiple connector interfaces and a single output interface or multiple output interfaces and a single connector interface without detracting from the spirit of the invention.

In accordance with a specific example, the set of external media sources 53a-e may include at least two external media sources, each external media source storing respective media content. The external media sources 53a-e in the set may be of a same type or of different types. In a specific example, the connector interfaces 260a-e are configured for engaging at least two different types of external media sources. In such an implementation, the multimedia source interface 50′ comprises a first interface connector suitable for coupling with a complementary connector of a first type associated with a first type of external media source and a second interface connector suitable for coupling with a complementary connector of a second type associated with a second type of external media source. In a non-limiting example of implementation, the first interface connector is a USB connector interface and the second interface connector is suitable for coupling with a complementary connector associated to an MP3 (or other audio format) player. It will be appreciated that the set of connector interfaces 260a-e may include multiple connector interfaces adapted for engaging a same type of external media source without detracting from the spirit of the invention.

In a specific implementation, the set of output interfaces 280a-c includes at least two output interfaces where each output interface is adapted to engage a respective output module. The output interfaces 280a-c in the set may be of a same type or of different types. In a specific example, the output interfaces 280a-c are configured for engaging at least two different types of output modules for example a first output module embodied as a display screen and a second output module embodied as a speaker. In such an implementation, the multimedia source interface 50′ comprises a first output interface suitable for communicating with a complementary interface of a first type associated with a first type of output module and a second output interface suitable for communicating with a complementary interface of a second type associated with a second type of output module. It will be appreciated that the set of output interfaces 280a-c may include multiple output interfaces adapted for engaging a same type of output module without detracting from the spirit of the invention.

The processing unit 241′ is analogous to processing unit 241 described with reference to FIG. 3 and implements similar functionality. The processing unit 241′ provides functional modules for enabling communication, through the bathing unit controller 30, between the control interface 32 shown in FIG. 2a and the set external media source 53a-d. In addition, where multiple output modules 52a-c are connected to the multimedia source interface 50, the processing unit 241′ provides functional modules for enabling communication between the output modules 52a-c and the external media sources 53a-e. The functional modules may, for example, implement communication protocols, signal format conversions and any other function required for enabling communication between the different components. Any suitable methods and techniques known in the art can be used for provided such communication capability without detracting from the spirit of the invention. The specific manner in which the functional modules enable the communication between the various components is not critical to the invention and as such will not be described in further detail here. The processing unit 241′ is also operative for generating and transmitting information to the control interface 32 (shown in FIG. 2a) via the bathing unit controller 30 for conveying to a user a listing of the set of external media sources 53a-e which are in communication with the multimedia source interface 50′.

Practical implementations of multimedia source interfaces and of control systems making use of a multimedia source interface will now be described for the purpose of illustration.

### Practical Implementation #1

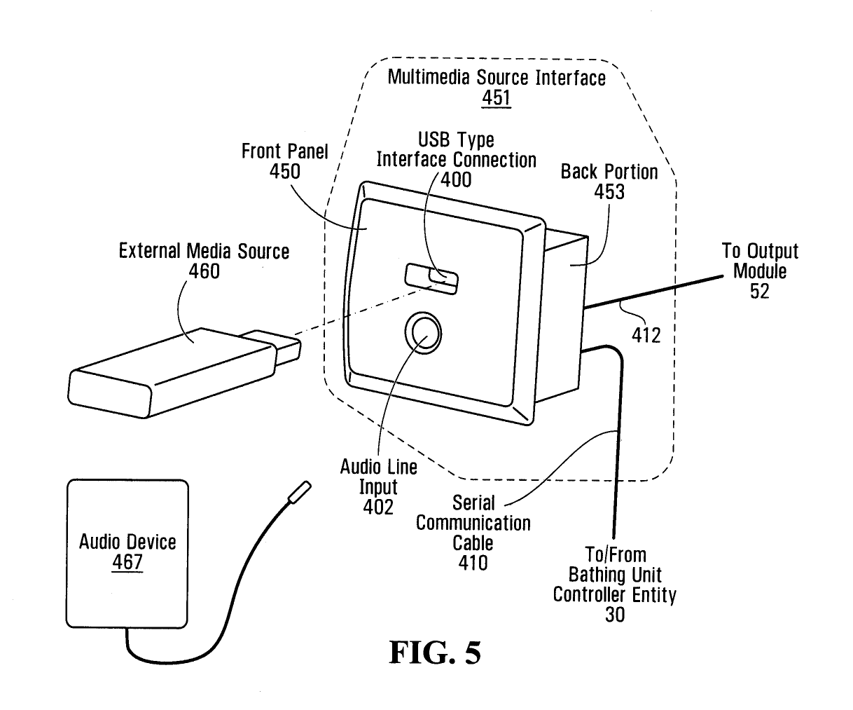

A first specific practical implementation of multimedia source interface will now be described with reference to FIG. 5 of the drawings. It will be appreciated that this practical implementation is depicted for the purpose of illustration and that various other implementations of multimedia source interfaces in accordance with the spirit of the invention are possible.

The multimedia source interface, designated with reference numeral 451, includes a front panel 450 with two interface connectors 402 and 400, a back portion 453 positioned in the back of the front panel 450 and holding a processing unit (not shown), a first communication link 410 for communicating with the bathing unit controller 30 and a second communication link 412 for transmitting media signals to an output module 52. The multimedia source interface 451 is also connected to a power source (not shown), which may be a local power source (such as a battery) or may be connected to an external power supply. The external power supply may be provided through the bathing unit controller 30 or through other suitable electrical wiring to the multimedia source interface 451.

The multimedia source interface 451 is configured to be mounted to a surface, such as an outside panel of a bathing unit or to a wall. The configuration shown is preferably mounted to a surface having a recess adapted for receiving the back portion 453 of the multimedia source interface 452 such that the front panel 450 covers that recess.

In the embodiment depicted, the first interface connector 400 is a serial USB type connector interface adapted for engaging a complementary connector associated with external media source embodied as a UFD (USB Flash Drive) 460. The UFD (USB Flash Drive) 460 stores media content such as for example, audio files, video files, electronic written media (e.g. newspaper, journals, bathing unit owner's manual) or any other suitable media content that a user of the bathing unit may want to access. The media content stored on the UFD (USB Flash Drive) 460 may be encoded using any suitable encoding protocol.

The second interface connector 402 is an audio input connector adapted for engaging an audio output line of an audio device 467.

The communication link 410 for communicating with the bathing unit controller 30 is embodied as a wired communication cable for carrying bi-directional communication signals between the bathing unit controller 30 and the multimedia source interface 451.

The communication link 412 for transmitting media signals to an output module 52 is embodied as a wired communication cable for carrying media signals to an output module. Depending on the type of output module and type of media signals to be carried, the communication link 412 will be embodied in a suitable physical medium for allowing the desired media signals to be communicated with the output module. For example, where the media signals is a video signal, the communication link 412 will be embodied in a physical medium providing sufficient bandwidth for carrying a video signal.

The processing unit (not shown in the figure) is located in the back portion 453 of the multimedia source interface 451 and is in communication with the two interface connectors 402 and 400, the first communication link 410 and the second communication link 412. The processing unit is adapted for implementing the functionality described with reference to processing units 241 and 241′ shown in FIGS. 3 and 4. In this specific example, the processing unit implements media content processing functionality for allowing functions associated to the media control commands originating from the control interface 32 to be executed in totality or in part by the processing unit. For example, the processing unit may include functional modules for implementing functions such as “PLAY”, “STOP”, “PAUSE”, “FAST FORWARD”, “REWIND”, “STEP FORWARD”, “STEP BACK”, “SHUFFLE”, “REPEAT” or any other desirable type of media function with respect to the media content. For example, where the processing unit may implement MP3 (or other audio format) player functionality, MP4 (or other video format) player functionality.

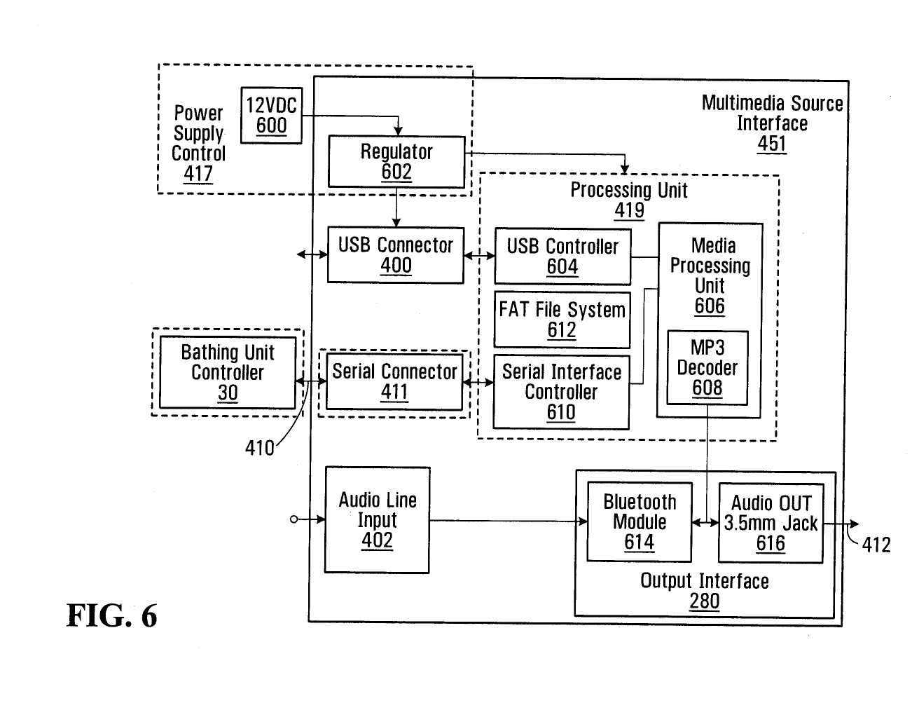

A non-limiting example of implementation of a processing unit suitable for in the multimedia source interface 451 is depicted in FIG. 6 of the drawings.

As depicted, the processing unit, designated with reference numeral 419, includes functionality for implementing a USB controller 604, a file allocation table (FAT) system module 612, a serial interface controller 610 and a media processing unit 606 including amongst others an MP3 decoder module 608. FIG. 6 also depicts in greater detail a specific implementation of an output interface 280 including a BLUETOOTH module 614 and an output audio jack 616. FIG. 6 also depicts a specific implementation of a power supply control module 417 including a battery 600 and a voltage regulator 602. Manners in which the various modules of the processing unit 419 can be implemented is well known to the person skilled in the art will vary from one implementation to the other. As such, these modules will not be described further here.

### Practical Implementation #2

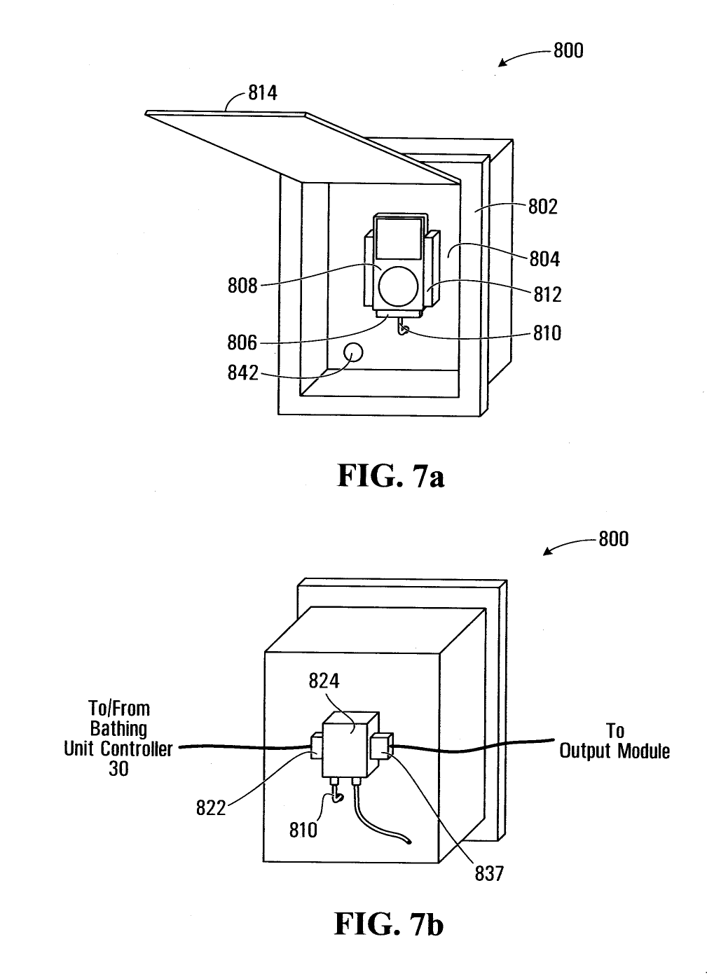

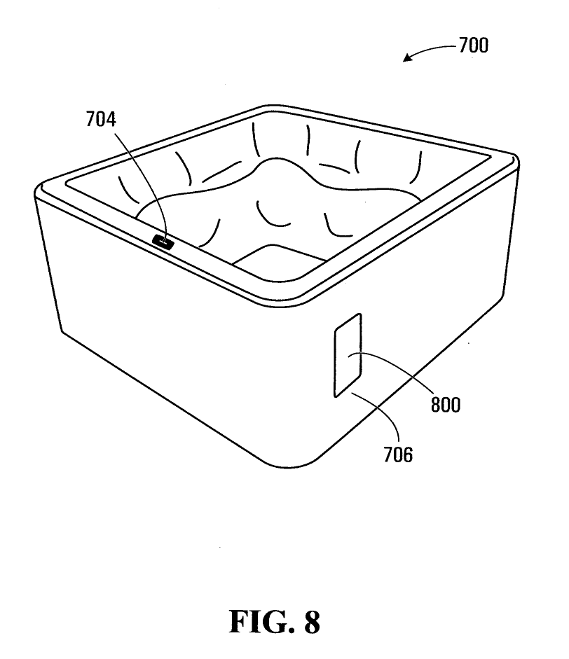

A second specific practical implementation of the multimedia source interface will now be described with reference to FIGS. 7a, 7b and 8 of the drawings.

The multimedia source interface, designated with reference numeral 800, includes a body defining a cavity 804 suitable for receiving therein an external media source 808 storing media content. The multimedia source interface 800 also includes an interface connector 806 positioned within the cavity 804 defined by the body. The interface connector 806 is of a suitable type for engaging a complementary connector (not shown) associated with the external media source 808 for accessing media content stored on the external media source 808. In the non-limiting example depicted, the external media source 808 is an MP3 player (or other equivalent audio format player). In a specific non-limiting example, the cavity 804 defined by the body of the multimedia source interface 800 is such that it can receive therein the external media source 808 so that the external media source 808 substantially lies within the cavity 804. Since different external media sources 808 may have different shapes and sizes, embodiments of the multimedia source interface 800 will have the cavities with different configurations. Although the example of implementation shown in FIG. 7a shows a single interface connector 806 positioned within the cavity 804, it will be appreciated that alternative implementations of the multimedia source interface 800 may includes multiple interface connectors positioned within the cavity 804 defined by the body of the multimedia source interface 800 without detracting from the spirit of the invention. As such, the apparatus may comprise a set of interface connectors positioned within the cavity defined by the body of the apparatus, the set of connectors including at least two connectors. The interface connectors in the set of interface connectors are suitable for engaging respective complementary connectors associated with external media sources of different types. In a specific implementation, the set of connectors includes at least two connectors that are suitable for coupling with different types of complementary connectors associated with external media sources.

Optionally, as shown in the specific example depicted in FIG. 7a, the multimedia source interface 800 includes one or multiple positioning members 812 for positioning the external media source 808 within the cavity 804. The positioning members 812 are adapted for releasably engaging the external media source 808 so that it can be securely positioned within the cavity 804. The positioning members 812 may have different configurations adapted for securing external media sources having different shapes. In the non-limiting example depicted, the multimedia source interface 800 includes two positioning members 812 adapted for resiliently securing the external media source 808 there between.

The multimedia source interface 800 also includes a communication entity 822 (shown in FIG. 7b) operative for exchanging signals with the bathing unit controller 30 and a processing unit 824 in communication with the interface connector 806 (over communication link 810) and the communication entity 822. The processing unit 824 is adapted for implementing similar functionality as that described with reference to processing units 241 or 241′ (shown in FIGS. 3 and 4). In the specific non-limiting example depicted, the processing unit 824 is responsive to media control commands received from the bathing unit controller 30 at communication entity 822 for causing a media signal to be generated by the external media source 808, the media signal conveying at least part of the media content stored on the external media source 808. More specifically, the processing unit 824 is responsive to media control commands received from the bathing unit controller 30 for transmitting signals conveying the media control commands to the external media source 808 over interface connector 806. The functions associated to the media control commands are executed by the external media source 808 on the basis of signals transmitted from the multimedia source interface. The external media source 808 then released the media signal for transmission to multimedia source interface 800 either through interface connector 806 or through another interface connector (not shown) on the multimedia source interface 800. The apparatus also includes an output interface 837 in communication with the processing unit 824. The output interface 837 is for releasing the media signal generated by the external media source 808 in a format suitable for causing an output module (not shown) to convey at least part of the media content associated with the external media source to a user.

In a specific example of implementation, the body of the multimedia source interface 800 is designed to be mounted to a surface, such as an outside panel of a bathing unit or to a wall. The configuration shown is preferably for mounting to a surface having a recess adapted for receiving the back portion of the multimedia source interface 800 such that the front panel 802 covers the recess. In a non-limiting implementation, for the installation of the multimedia source interface 800, a recess is created in the outside panel of the bathing unit for receiving therein the body of the apparatus. FIG. 8 of the drawings depicts a bathing unit system 700 with the multimedia source interface 800 positioned on an outside panel 706 of the bathing unit receptacle. FIG. 8 also shows a control interface 704 positioned on the topside of the bathing unit receptacle. The control interface 704 is analogous to control interface 32 (depicted in FIG. 2a) and is in communication with the multimedia source interface 800 through a bathing unit controller (not shown in the figure).

Referring back to the specific example of implementation depicted in FIG. 7a, the multimedia source interface 800 includes a cover member 814 for engaging the body multimedia source interface 800 such as to substantially enclose the cavity 804 defined by the body. The cover member 814 may be a component that can be separated from the body during normal use or may be moveably connected to the body. In the specific implementation shown, the cover member 814 is hingedly connected to the body and is movable between a first position in which it substantially encloses the cavity 804 defined by the body and a second position in which it allows access to a user to the cavity 804 defined by the body. In a specific implementation, the cover member 814 is suitable for engaging the body such as to substantially prevent water from entering the cavity 804 during use of the bathing unit system.

In a specific example of implementation, the body of the multimedia source interface includes a communication disconnect member (not shown in the figures) adapted for causing the interface connector 806 to acquire a state in which the device 808 can be safely disconnected from the interface connector 806. More specifically, while the device 808 is being accessed by the multimedia source interface 800 through interface connector 806, disconnecting the device 808 may cause damage to either the external media source 808 or the connector 806. Such damage may cause media content on the device 808 to be lost or corrupted for example. In addition, when the multimedia source interface 800 is positioned near water, the users of the system may be wet when accessing the multimedia source interface 800. In such cases, the communication disconnect member provides a mechanism that may be used for removing power from the multimedia source interface 800 during user access to prevent unsafe situation.

In a specific example of implementation, the communication disconnect member includes a circuit element in communication with the cover member 814. When the cover member 814 is engaged with the body such as to substantially enclose the cavity 804 defined by the body, the circuit element enables power to be communicated to the connector 806 and enables the multimedia source interface 800 to access media content on the external media source 808. When the cover member is positioned such as to allow access to a user to the cavity 804 defined by the body, the circuit element in the communication disconnect member prevents power to be communicated with the connector 806 so that the external media source 808 can be disconnected from the multimedia source interface 800.

Alternatively, the communication disconnect member is in the form of a user controllable device (not shown in the figure). The user controllable device can be actuated by a user to cause the connector 806 to acquire a first state in which access to the external media source 808 is permitted and the external media source 808 can be safely physically disconnected from the connector 806. The user controllable device can also be actuated by a user to cause the connector 806 to acquire a second state in which the external media source 808 should not be physically disconnected from the connector 806 since disconnection may cause damage to either the external media source 808 or the connector 806. In practical implementations, the user controllable device may be in the form of a button or a switch.

In yet another alternative embodiment, the communication disconnect member include a circuit element in communication with the one or multiple positioning members 812. The circuit element of the communication disconnect member is adapted for detecting when the external media source 808 is dislodged from the positioning members 812 to cause the connector 806 to acquire a state in which the external media source 808 can be safely physically disconnected from the connector 806. Such a circuit element may include for example an optical sensor for detecting the presence of the external media source 808 at the positioning members 812.

It will be appreciated that other embodiments for the communication disconnect member may be used for causing the interface connector 806 to acquire a state in which the device 808 can be safely disconnected from the interface connector 806 without detracting from the spirit of the invention.

In a specific example of implementation, a visual indicator 842 is provided for indicating to the user whether or not the external media source 808 can be safely physically disconnected from the connector 806. The visual indicator 842 may, for example, be positioned in proximity to the multimedia source interface 800, on the exterior surface of the body of the multimedia source interface 800, on the cover member 814 or within the cavity 804 defined by the body of the multimedia source interface 800. In a non-limiting example, the visual indicator 842 is in the form of a light element, for example an LED. The LED conveys to a user that the external media source 808 should not be physically disconnected from the connector 806 when the LED is “ON” and that the external media source 808 may be safely physically disconnected from the connector 806 when the LED is “OFF”. Other manners for conveying whether or not the external media source 808 can be safely physically disconnected from the connector 806 may be envisaged by the person skilled in the art in light of the present description without detracting from the spirit of the invention.

### Practical Implementation #3

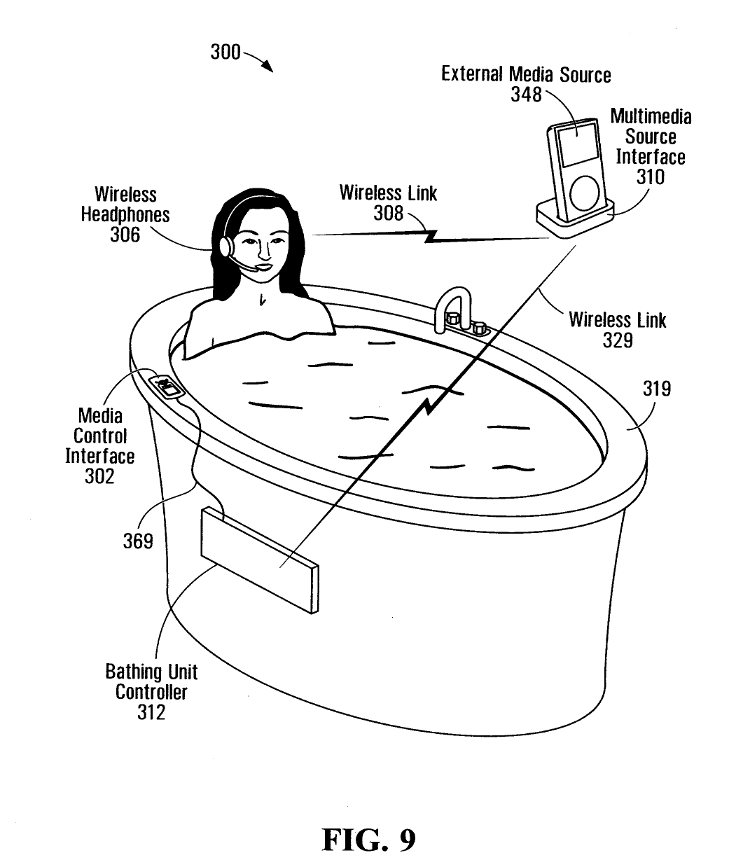

A third specific practical implementation of the multimedia source interface will now be described with reference to FIG. 9 of the drawings.

The multimedia source interface, designated with reference numeral 310, is part of a control system for a bathing unit system 300, the control system being suitable for controlling a set of bathing unit components and for providing multimedia functionality to the user. As illustrated, the bathing unit system 300 includes a bathing unit receptacle 319, a control system and a set of bathing unit components. For the purpose of simplicity, the set of bathing unit components, which may include components similar to those depicted in FIG. 1 of the drawings, have been omitted from the illustration depicted in FIG. 9. The control system includes a multimedia source interface 310 in communication with a bathing unit controller 312 over communication link 329. The bathing unit controller 312 is analogous to bathing unit controller 30 (shown in FIG. 2a) an implements similar functionality. The multimedia source interface 310 is analogous to the multimedia source interfaces 50 or 50′ described above with reference to FIGS. 2, 3 and 4 of the drawings and implements similar functionality. In this example, communication link 329 is a wireless link.

As shown, the multimedia source interface 310 includes one or more connector interfaces for enabling access to media content associated with one or more external media sources including external media source 348. The multimedia source interface 310 includes an output interface for releasing a signal suitable for causing an output module to convey at least part of the media content associated with the external media source 248 to a user. In the specific embodiment depicted, the output interface is adapted for communicating with an output module embodied as a wireless headset 306 or other wireless speaker device over wireless communication link 308. Any suitable communication protocol for providing communication between the multimedia source interface 310 and the wireless headset 306 may be used. In a non-limiting example of implementation, a communication protocol for close proximity audio communication, such as the BLUETOOTH protocol, is used.

The control system also includes a media control interface 302 in communication with the bathing unit controller 312 over communication link 369. In this specific example, communication link 369 is a wired connection. The media control interface 302 is shown as being positioned in the topside of the bathing unit receptacle 319 and is accessible by a user located in the bathing unit receptacle 319 however it may also be positioned in other suitable locations on the bathing unit receptacle. The media control interface 302 is analogous to media control interface 55 (shown in FIG. 2b) and implements similar functionality.

The media control interface 302 enables a user to access the external media source 248 and to control the functions of the external media source 248. More specifically, using the controls on the media control interface 302, the user can enter a media control command to obtain information associated to media content associated with the external media source 348. The media control command is transmitted over communication link 369 to the bathing unit controller 312 and then over communication link 329 to the multimedia source interface 310. The multimedia source interface 310 then sends a signal to the external media source 348 conveying the media control command. A signal conveying the requested information is then generated and transmitted from the multimedia source interface 310 through bathing unit controller 312 for display at the media control interface 302. Such information may include for example a listing of the media content on the external media source 248.

The user may also use the controls on the media control interface 302 to enter a media control command for causing a signal to be released at the output interface of the multimedia source interface 310 for causing the wireless headset 306 to release an audio signal derived from media content associated with the external media source. The media control command is transmitted over communication link 369 to the bathing unit controller 312 and then over communication link 329 to the multimedia source interface 310. The multimedia source interface 310 then sends a signal to the external media source 348 conveying the media control command. A media signal is generated conveying media content associated to the external media source 248. The media signal is then released at the output interface of the multimedia source interface 310 for transmittal over wireless link 308 to the wireless headset 306 for causing the headset 306 to convey an audio signal derived from media content associated to the external media source 248.

### Practical Implementation #4

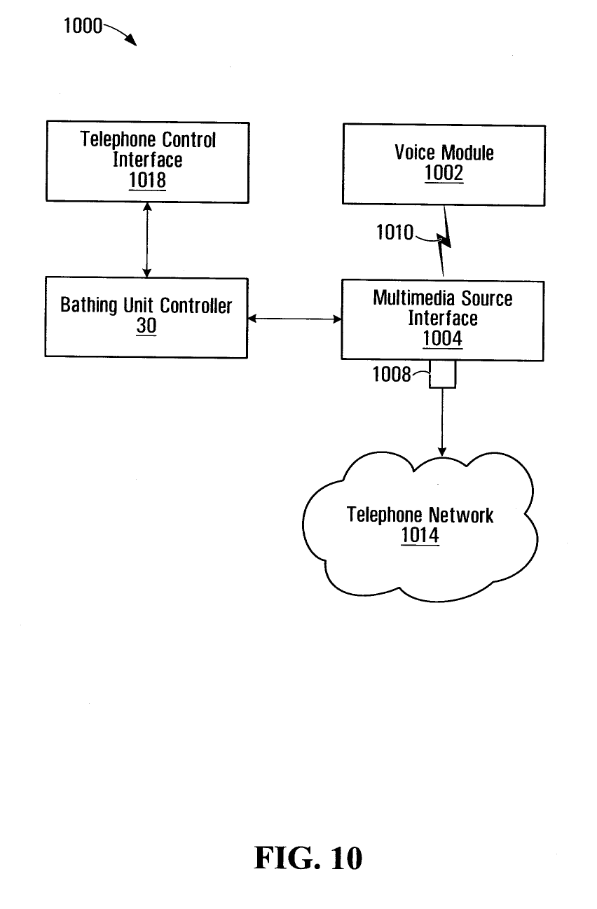

A fourth specific practical implementation of multimedia source interface will now be described with reference to FIG. 10 of the drawings.

The multimedia source interface, designated with reference numeral 1004, is part of a control system 1000 for a bathing unit system, the control system 1000 being suitable for controlling a set of bathing unit components in a bathing unit system and for providing telephony related functionality. The control system 1000 comprises a bathing unit controller 30 suitable for issuing signals for controlling a set of bathing unit components in a bathing unit system. The control system 1000 also comprises a multimedia source interface 1004 in communication with the bathing unit controller 30, the multimedia source interface 1004 enabling access to a telephone network 1014. The multimedia source interface 1004 is analogous to the multimedia source interface 50 described above with reference to FIGS. 2a, 2b and 3 and may implement similar communication interconnection functionality. The control system 1000 also includes a telephone control interface 1018 in communication with the bathing unit controller 30. The telephone control interface 1018 is operative for enabling a user within the bathing unit system to access the telephone network 1014 by sending a telephone control command to the multimedia source interface 1004 through the bathing unit controller 30. In a specific non-limiting example of implementation, the telephone control interface 1018 includes an auxiliary telephone keyboard including a dial pad and actuators for picking up a call and terminating a call. Alternatively, the telephone control interface 1018 includes other user operable inputs for performing telephone-related actions or other functionality, such as, for example, speech recognition capability for enabling voice dialing. The telephone control interface 1018 may be a standalone control interface or may be an integral part of a bathing unit control interface, where the bathing control interface is operative for enabling a user to enter information indicative of a desired change in a certain operational setting of the bathing unit system.

The multimedia source interface 1004 includes one or more connector interfaces, including connector interface 1008, for establishing a communication link with the telephone network 1014. The connector interface 1008 may be a standard telephone jack providing for a wired connection to the telephone network 1014 or may be of form suitable for engaging a mobile (cellular type) phone. Telephone-related functionality, including call-pick-up, call termination and initiating a telephone call, may be implemented either by the multimedia source interface 1004, by the telephone control interface 1018 or by a peripheral unit (not shown in the figure) to be connected between the telephone network 1014 and connector interface 1008.

The multimedia source interface 1004 includes an output interface for releasing a signal suitable for causing a voice module 1002 to convey audio signals to a user. In the specific embodiment depicted the output interface is adapted for communicating with an output module embodied as a wireless headset over wireless communication link 1010. Any suitable communication protocol for providing communication between the multimedia source interface 1004 and the headset may be used. In a non-limiting example of implementation, a communication protocol for close proximity audio communication, such as the BLUETOOTH protocol, is used for providing communication between the voice module 1002 and the multimedia source interface 1004. It will be appreciate that although the communication link 1010 between the voice module 1002 and the multimedia source interface 1004 has been depicted as a wireless link, embodiments where communication link 1010 is a wired link are possible without detracting from the spirit of the invention. The voice module 1002 includes an audio output for conveying voice signals transmitted by the multimedia source interface 1004 and originating from the telephone network 1014. Optionally, the voice module 1002 also includes a microphone and is adapted for transmitting signals derived from a spoken utterance of a user at the voice module 1002 to the multimedia source interface 1004 for transmission to the telephone network 1014. Alternatively, a microphone is provided at telephone control interface 1018 instead or in addition to the microphone at the voice module 1002. Where the telephone control interface 1018 includes a microphone for receiving voice signals from the user of the bathing unit system, the voice signals are transmitted to the telephone network 1014 by traveling through the bathing unit controller 30 and the multimedia source interface 1004.

### Practical Implementation #5

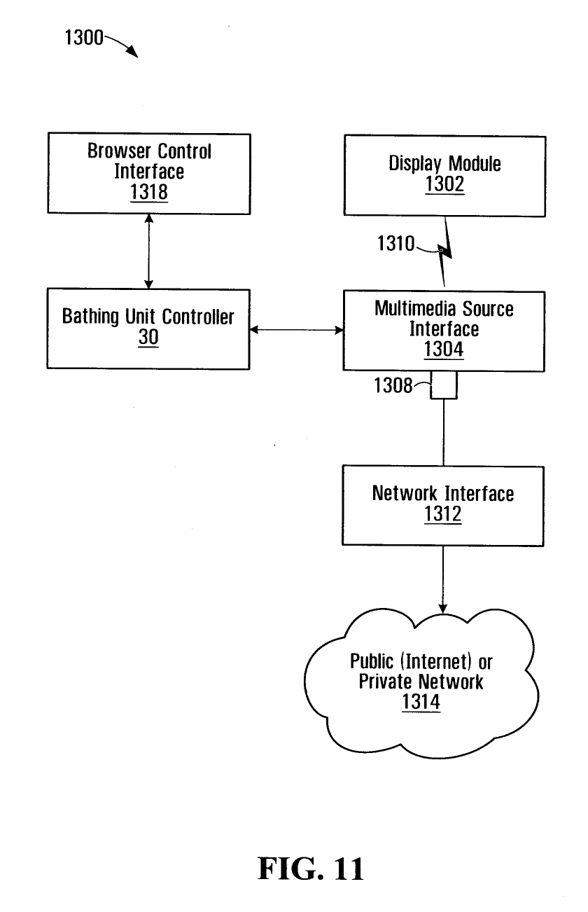

A fifth specific practical implementation of multimedia source interface will now be described with reference to FIG. 11 of the drawings. The multimedia source interface, designated with reference numeral 1304, is part of a control system 1300 for a bathing unit system, the control system 1300 being suitable for controlling a set of bathing unit components in a bathing unit system and for providing data network access functionality. The control system 1300 comprises a bathing unit controller 30 suitable for issuing signals for controlling a set of bathing unit components in a bathing unit system.

The control system 1300 also comprises a multimedia source interface 1304 in communication with the bathing unit controller 30, the multimedia source interface 1304 enabling access to a public or private network 1314 (e.g. INTRANET or INTERNET).

The multimedia source interface 1304 is analogous to the multimedia source interfaces 50 described above with reference to FIGS. 2a, 2b and 3 and may implement similar communication interconnection functionality. The multimedia source interface 1304 includes a port 1308 suitable for communicating with a network interface device 1312. The multimedia source interface 1304 also includes a port for communicating with a display module 1302. In the embodiment depicted the multimedia source interface 1304 communicates with the display module 1302 over a wireless communication link 1310 however it may communicate with over a wired communication in alternative specific examples of implementation without detracting from the spirit of the invention.

The control system 1300 also includes a browser control interface 1318 in communication with the bathing unit controller 30. The browser control interface 1318 is operative for enabling a user to access the public or private data network 1314 (INTRANET or INTERNET) by sending a data network control command to the multimedia source interface 1304 through the bathing unit controller 30. The browser control interface 1318 includes an input module allowing a user to provide commands for accessing various information on network 1314. Such an input device may include a keyboard, pointing device, touch sensitive screen or any other suitable type of user operable input device. The browser control interface 1318 may be a standalone control interface or may be an integral part of a bathing unit control interface, where the bathing control interface is operative for enabling a user to enter information indicative of a desired change in a certain operational setting of the bathing unit system.

The multimedia source interface 1304 includes one or more connector interfaces, including connector interface 1308, for establishing a communication link with the public or private data network 1314 (INTRANET or INTERNET). The connector interface 1308 may be a standard Ethernet jack providing for a wired connection to the network interface device 1312 or may be in a form suitable for engaging a wireless network interface device. The network interface device 1312 may be any device suitable for providing network connectivity. Such devices are beyond the scope of the present application and as such will not be described further here. Moreover, although the network interface device 1312 has been shown to be a component separate from the multimedia source interface 1304, the of the network interface device 1312 may be imbedded in the multimedia source interface 1304 in certain specific examples of implementation of the invention.

The multimedia source interface 1304 also includes an output interface for releasing a signal suitable for causing display module 1302 to display information to a user in visual format. It will be appreciated that although the display module 1302 has been shown as being connected to the multimedia source interface 1304, in alternative embodiments the display module 1302 will be connected to the browser control interface 1318 or will be an integral part of the browser control interface 1318. In such an alternative implementation, the browser control interface 1318 will preferably includes required browser type software components for displaying to a user information obtained for the public or private data network 1314 (INTRANET or INTERNET). Alternatively, such software may be included as part of the multimedia source interface 1314 or as part of the network interface 1312.

### Control Interface

Exemplary embodiments of the control interface 32 depicted in FIG. 2a will now be described. For the purpose of the present description, the examples described will be directed to a control interface 32 enabling a user of the bathing unit system to control the operational settings of the bathing unit and to control multimedia functionality, telephone-related functionality and data network access functionality. It will be apparent to the person skilled in the art in light of the present description that embodiments of the invention providing multiple interfaces for controlling sub-combinations of these functions are possible without detracting from the spirit of the invention.

As depicted in FIG. 2a, the control interface 32 communicates with the multimedia source interface 50 by sending signals through the bathing unit controller 30. Similarly, the control interface 32 receives incoming signals from the bathing unit controller 30. Such incoming signals include signals conveying operational settings of the bathing unit and signals originating from the multimedia source interface 50 including signals related to multimedia functionality, telephone functionality and/or data network access functionality.

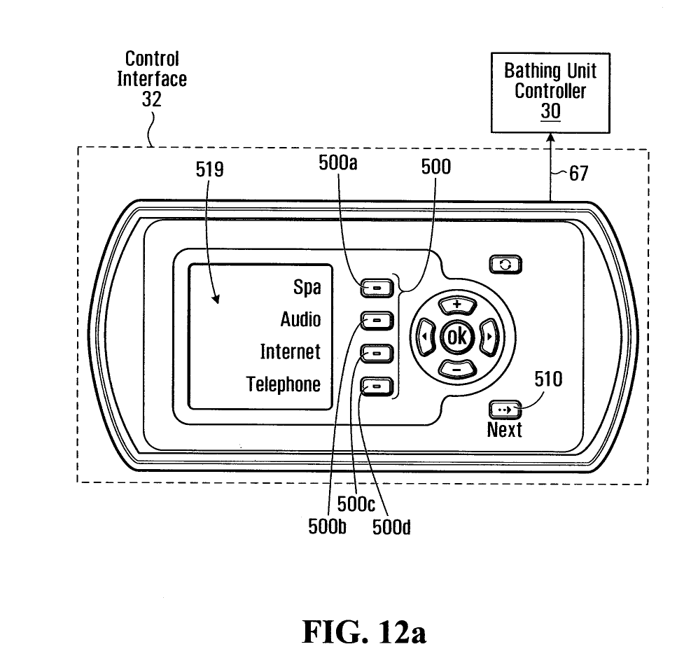

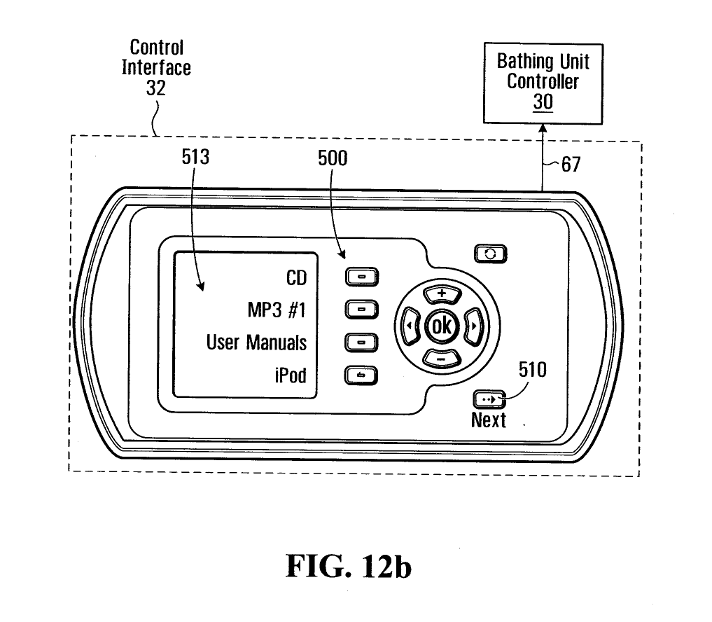

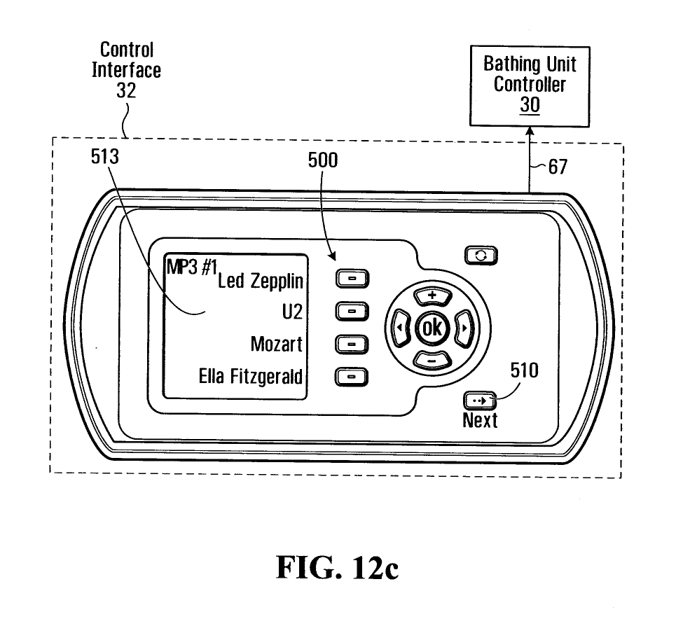

With reference to FIGS. 12a-12c, there is shown a control interface 32 suitable for use in the control system shown in FIG. 2a. The control interface 32, in accordance to the practical implementation depicted, includes a display screen 513, a set of user operable controls for allowing a user to enter commands and a processing unit (not shown) implementing the functionality of the control interface 32. The control interface 32 will typically be installed such as to be accessible by a user making use of the bathing unit system and is in communication with the bathing unit controller 30 over communication link 67.

In the example depicted, the user operable controls on the control interface 32 are in the form of keys or buttons. Each button or key is associated with a respective function that is activated when the key is pressed. It will be appreciated that other suitable types of user operable controls may be provided for allowing a user to enter commands such as, for example, a microphone connection to a speech recognition unit and a touch sensitive screen amongst others.

The display screen 513 provides information to the user about the bathing unit components in the bathing unit system 10 (depicted in FIG. 1) and provides a menu driven interface. In the specific embodiment depicted, the function associated to a given button or key on the control interface 32 will be modified depending on the information displayed on the display screen 513.

More specifically, the control interface 32 can be configured to provide control to a number of components in the bathing unit system including, without being limited to, multimedia functionality, telephony functionality, internet browsing functionality and the regulation of the operation of the bathing unit system, amongst others. In order to allow the user to control these various components, the control interface 32 provides a menu driven interface displayed in the display screen 513 allowing the user to select the components or functionality that he wishes to control. In the example shown in FIG. 12a, the display screen 513 displays a menu list with the following elements/options:
SPA
AUDIO
INTERNET
TELEPHONE

But actuating a button in the set of buttons 500, the element in the menu list aligned with the actuated button is selected. In order for the user to access the audio system, for example, the user actuates button 500b. Similarly, in order for the user to access the Internet system, the user actuates button 500c and so on.

When the “AUDIO” sub-menu is selected by the user by actuating button 500b aligned with the menu element “AUDIO”, media control signals are caused to be transmitted from the control interface 32 to the bathing unit controller 30 over communication link 67 and then are communicated to the multimedia source interface 50 (all shown in FIG. 2a). In response, the multimedia source interface 50 causes a signal to be transmitted to the control interface 32 through the bathing unit controller 30, the signal conveying information associated with external media sources connected to the multimedia source interface 50. Where multiple external media sources are connected to the multimedia source interface 50, information conveying the set of external media sources is transmitted to the control interface 32.

FIG. 12b depicts an exemplary embodiment of the control interface 32 and the display screen 513 when the user actuates button 500b aligned with the menu element “AUDIO” in FIG. 12a.

As shown, in response to the actuation of actuates button 500b in FIG. 12a, a new listing of elements is displayed in display screen 513. In this specific implementation, the listing includes media source information conveying a set of external media sources that can be controlled from the control interface 32. This set of external media sources is in communication with the control interface 32 though the multimedia source interface 50 and bathing unit controller 30 as depicted in FIG. 2a of the drawings. In the example shown in FIG. 12b, the display screen 513 displays a menu list with the following external media sources as options:
CD
MP3 #1
User manuals
IPOD

Optionally, as depicted in FIG. 12b, the control interface 32 includes a button 510 allowing the user to view additional menu items on the display screen. In order to issue a request to obtain information related to media content associated to an external media source listed on the display screen 513, the user can select the desired external media source by actuating the corresponding button in the set of buttons 500.

FIG. 12c depicts an exemplary embodiment of the control interface 32 and the display screen 513 when the user actuates button 500b aligned with the menu element “MP3 #1” in FIG. 12b.

As shown a new listing of elements is displayed in display screen 513. In this specific implementation, listing includes a listing of media elements stored on the external media source. In the example shown in FIG. 12c, the display screen 513 displays a menu list with the following media elements as options:
Led Zepplin
U2
Mozart
Ella Fitzgerald

Optionally, as depicted in FIG. 12c, the control interface 32 includes a button 510 allowing the user to scroll a menu to view additional menu items on the display screen. In the non-limiting example of information depicted, the listing of media elements includes artist names and/or band names. Other types of media elements may include, without being limited to, audio album titles, song titles, artist names, movie titles and written media identifiers.

In order to cause media content associated to an element listed on the display screen 513, the user can select the desired element by actuating the corresponding button in the set of buttons 500. For example, by actuating button 500c, media content associated to the media element “U2” will be conveyed to a user. It will be appreciate that media element “U2” may itself be associate with another list of media elements and that selecting this media element will cause an additional level of hierarchy to be displayed in the display screen 513.

In addition, when in the “AUDIO” submenu, the buttons on the control interface 32 other than buttons in the 500 are associated to respective multimedia function, such as “PLAY”, “STOP”, “PAUSE”, “FAST FORWARD”, “REWIND”, “STEP FORWARD”, “STEP BACK”, “SHUFFLE”, “REPEAT” or any other suitable type of media function with respect to media content. By actuating selected ones of the buttons on the control interface 32, a user can cause media content associated to a given media element to be conveyed to a user of the bathing unit system.

Referring back to the example shown in FIG. 12a, in order for a bathing unit user to initiate a telephony-related action, the user actuates button 500d aligned with the menu element “TELEPHONE”. In response to the actuation of button 500d, the display 513 will show a telephone control interface enabling a user to initiate a telephone function. Menu items may provide options including, without being limited to:
CALL PICK-UP
DIAL
CALL TERMINATE

Optionally, the display 513 includes a touch sensitive screen and the actuation of button 500d causes a telephone dial pad to be displayed on display 513 so that the user can dial a telephone number or perform other telephone functions such as picking up a call and terminating a call. Alternatively, embodiments of the control interface 32 providing telephone-related functionality include a telephone keyboard including a dial pad and actuators for picking up a call and terminating a call. Optionally the control interface 32 providing telephone-related functionality includes a microphone (not shown) for receiving voice signals from the bathing unit user.

The control interface 32 allows a user to enter telephone control commands at the control interface 32. The telephone control commands convey a telephone function, such as picking up a call, terminating an call, dialing a phone number, looking up a telephone number in a directory or any other suitable type of telephone function. The telephone control commands provided by the user are transmitted from the control interface 32 to the bathing unit controller 30 over communication link 67 and then communicated to the multimedia source interface 50 (shown in FIG. 2a). Where the control interface 32 includes a microphone (not shown) for receiving voice signals from the bathing unit user, the voice signals obtained by the microphone are also transmitted from the control interface 32 to the bathing unit controller 30 over communication link 67 and then communicated to the multimedia source interface 50.

Referring back to the example shown in FIG. 12a, in order for a bathing unit user to access a data network such as the Internet, the user actuates button 500c aligned with the menu element “INTERNET”. In response to the actuation of button 500c, the display 513 will show a browser interface enabling a user to access and navigate in a data network. Any suitable browser software may be used for providing such functionality. Optionally, embodiments of the control interface 32 providing Internet access functionality include a keyboard, pointing device, voice input (in combination with speech recognition functionality) or other suitable user operable input for enabling a user to navigate and access desired locations on the Internet. The web-pages or other content on the network may be displayed on display screen 513 or on some other display module. The other display module may be connected to the control interface 32 or alternatively may be connected to the multimedia source interface 1304 as an output module 1302 in the manner shown in FIG. 11.

The control interface 32 allows a user to enter data network control command at the control interface 32. The data network control commands allow a user to access and navigate in a data network. The data network control commands provided by the user are transmitted from the control interface 32 to the bathing unit controller 30 over communication link 67 and then communicated to the multimedia source interface 50.

It will be appreciate that the display functionality described with respect to the data network access functionality may equally apply where the control interface 32 provides the capability of displaying electronic written documents. Such electronic publications may include, without being limited to, bathing unit user manuals and electronic publications of newspapers, journals or any other suitable type of documents. Such documents may be stored in any suitable format on an external media source or may be stored locally on in a memory module located at the bathing unit controller 30 or at the control interface 32 itself. In such implementations, the control interface 32 includes functionality allowing accessing and navigating the documents. This may include, for example, user operable inputs such as a keyboard, pointing device, voice input (in combination with speech recognition functionality) or other suitable user operable input for enabling a user to navigate and access documents. The documents may be displayed on display screen 513 or on some other display module. The other display module may be connected to the control interface 32 or alternatively may be connected to the multimedia source interface 1304 as an output module 1302 in the manner shown in FIG. 11. Suitable software modules for viewing the electronic written documents may be provided either locally at the control interface 32 or through a component in communication with the multimedia source interface.

Variant of Control Interface 32 with Integrated Multimedia Source Interface

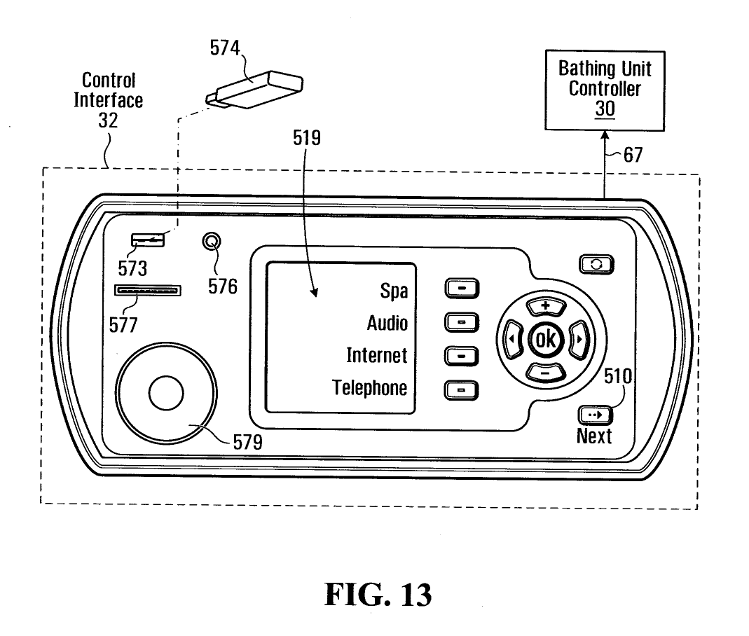

FIG. 13 of the drawings depicts a non-limiting specific example of implementation of a variant of the control interface 32 including an integrated multimedia source interface.

As shown, the control interface 32 includes, in addition to the components of the control interface described with reference to FIGS. 12a to 12c, a set of connector interfaces 573 576 577 and an output module 579 in the form of an audio speaker. In the embodiment depicted the set of connector interfaces 573 576 577 includes an audio line input 576, a port 577 adapted for engaging an digital audio player such as an MP3 player and a USB type connector interface 573 adapted for engaging a USB Flash drive 574. The processing unit (not shown) of the control interface 32, in addition to implementing functionality described with reference to FIGS. 12a to 12c, is adapted for implementing functionality described in connection with processing units 241 and 241′ (shown in FIGS. 3 and 4). In this implementation, the display screen 513 of the control interface 32 can also be used as an output module for displaying video media content and/or text stored on an external media source.

### CONCLUSION

Those skilled in the art will appreciate that various modifications and refinements can be made to the embodiments presented above without detracting from the scope of the present invention.

It is to be understood that the functionality of the multimedia source interface could be implemented by any suitable hardware and/or hardware/software combination without departing from the spirit and scope of the present invention. In a non-limiting example, the multimedia source interface includes a microprocessor. In addition, it will also be appreciated that the functionality of the multimedia source interface could be implemented by other suitable circuitry, including, by way of example only, an application-specific integrated circuit (ASIC), or discrete logic circuitry.

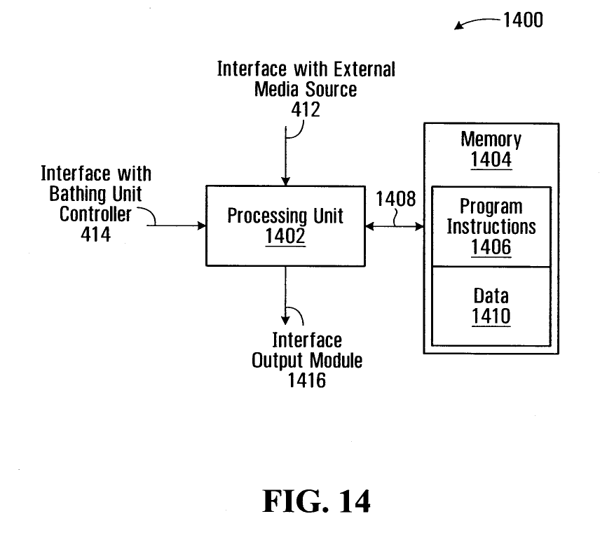

The apparatus implementing a multimedia source interface for providing multimedia functionality, telephony-related functionality and/or data network access functionality may also be configured as a computing unit 1400 of the type depicted in FIG. 14, including a processing unit 1402 and a memory 1404 connected by a communication bus 1408. The memory 1404 includes data 1410 and program instructions 1406. The processing unit 1402 is adapted to process the data 1410 and the program instructions 1406 in order to implement the functional blocks described in the specification and depicted in the drawings. In a non-limiting implementation, the program instructions 1406 implement the functionality of processing unit 241 or processing unit 241′ described above. The computing unit 1400 may also comprise a number of interfaces 1412 1414 1416 for receiving or sending data elements to external devices. For example, interface 1412 is used for receiving data streams conveying media control from an external media source and interface 1414 is used for receiving a control signals from the from a bathing unit controller. Interface 1416 is for releasing a media signal for causing an output module convey media content the user on the basis of the program instructions 1406 and the media content received at interface 1412.

In addition, although certain embodiments of the control system 600, control interface 32 and the multimedia source interface 50 have been described where multimedia functionality, telephony-related functionality and data network access functionality have been provided separately, it will be appreciated that embodiments of the control system and the multimedia source interface providing various combinations of the above functionalities are within the scope of the present invention. For example, a control system having a multimedia interface suitable for enabling access to media content associated with an external media source and for enabling access to a data network and/or a telephone network. In addition, the multimedia functionality, telephony-related functionality and data network access functionality may be controllable by a user of the bathing unit system from a same centralized control interface or through multiple control interfaces in communication with the multimedia source interface through the bathing unit controller.

The above description of the embodiments should not be interpreted in a limiting manner since other variations, modifications and refinements are possible within the spirit and scope of the present invention. The scope of the invention is defined in the appended claims and their equivalents.

1. A control system suitable for controlling a set of bathing unit components in a bathing unit system, the set of bathing unit components including a heating module, said control system comprising:
a) a bathing unit controller suitable for issuing signals for controlling the set of bathing unit components in the bathing unit system;
b) a multimedia source interface in communication with said bathing unit controller, said multimedia source interface enabling access to media content associated with an external media source;
c) a control interface in communication with said bathing unit controller, said control interface being operative for:
i) enabling a user to enter information indicative of a desired change in a certain operational setting of the bathing unit; and
ii) enabling a user to enter a media control command to cause media content associated with the external media source to be conveyed to the user.

2. A control system as defined in claim 1, wherein said multimedia source interface includes a connector interface for exchanging signals with the external media source.

3. A control system as defined in claim 1, wherein said multimedia source interface includes an interface connector suitable for coupling with a complementary connector associated with the external media source.

4. (canceled)

5. (canceled)

6. (canceled)

7. A control system as defined in claim 1, wherein said multimedia source interface includes a connector interface suitable for exchanging signals with an external media source selected from the set consisting of an MP3 player, a USB flash drive, a CD-drive, a CD changer, a radio source and a computer hard drive.

8. (canceled)

9. A control system as defined in claim 1, wherein said multimedia source interface and the bathing unit controller are adapted for communicating with one another over a wireless communication link.

10. A control system as defined in claim 9, said control system including:
a) a first wireless transceiver associated with said multimedia source interface;
b) a second wireless transceiver associated with said bathing unit controller;
c) said first wireless transceiver and said second wireless transceiver being adapted for establishing a wireless communication link between said multimedia source interface and said bathing unit controller.

11. A control system as defined in claim 3, wherein said multimedia source interface includes a media processing unit adapted for:
a) accessing media content stored on the external media source over the interface connector; and
b) processing the media content to generate a media signal suitable for causing an output module to convey at least part of the media content associated with the external media source to a user.

12. A control system as defined in claim 11, wherein the multimedia source interface includes an output interface, said media processing unit adapted for releasing the media signal at the output interface.

13. A control system as defined in claim 11, wherein said media processing unit includes MP3 player functionality.

14. A control system as defined in claim 11, wherein said media processing unit includes MP4 player functionality.

15. A control system as defined in claim 1, wherein said multimedia source interface is adapted for exchanging signals with a set of external media sources, the set of external media sources including at least two external media sources, each external media source in the set of external media sources storing respective media content.

16. A control system as defined in claim 15, wherein said multimedia source interface comprises a plurality of connector interfaces, each connector interface in said plurality of connector interfaces being adapted for exchanging signals with a respective type of external media source.

17. A control system as defined in claim 15, wherein said multimedia source interface comprises:
a) a first interface connector suitable for coupling with a complementary connector of a first type associated with a first type of external media source;
b) a second interface connector suitable for coupling with a complementary connector of a second type associated with a second type of external media source.

18. A control system as defined in claim 17, wherein said first interface connector is a USB connector interface and wherein said second interface connector is suitable for coupling with a complementary connector associated to an MP3 player.

19. A control system as defined in claim 15, wherein said control interface includes a display unit, said control interface being adapted for:
a) displaying media source information conveying the set of external media sources;
b) enabling a user to enter information for selecting a certain external media source from the set of external media sources.

20. A control system as defined in claim 1, wherein said control interface includes a display unit, said control interface being adapted for displaying a listing of media elements stored on the external media source.

21. A control system as defined in claim 20, wherein the listing of media elements stored on the external media source includes entries selected from the set consisting of audio album titles, song titles, artist names, movie titles and written media identifiers.

22. A control system as defined in claim 21, wherein said control interface being adapted for:
a) enabling a user to enter information for selecting a media element from the listing of media elements;
b) causing media content associated to the selected media element to be conveyed to a user of the bathing unit system.

23. A control system as defined in claim 1, wherein the multimedia source interface includes an output interface for releasing a signal suitable for causing an output module to convey at least part of the media content associated with the external media source to a user.

24. A control system as defined in claim 23, wherein the media control command is a first media control command, said control interface is operative for enabling the user to enter a second media control command for causing a signal to be released at the output interface of the multimedia source interface for causing the output module to convey at least part of the media content associated with the external media source to a user.

25. A control system as defined in claim 23, wherein the output interface is suitable for establishing a connection with a speaker module.

26. (canceled)

27. (canceled)

28. (canceled)

29. A control system as defined in claim 23, wherein the output interface is suitable for establishing a connection with a display module.

30. (canceled)

31. (canceled)

32. An apparatus for providing multimedia functionality for use in a bathing unit system, said apparatus implementing a multimedia source interface comprising:
a) an interface connector adapted for establishing a communication link with an external media source for accessing media content stored on the external media source;
b) a communication entity operative for exchanging signals with a bathing unit controller, said communication entity being operative for receiving signals conveying media control commands from the bathing unit controller;
c) a processing unit in communication with said interface connector and said communication entity, in use said processing unit being responsive to media control commands received from the bathing unit controller for causing a media signal to be generated, the media signal conveying at least part of the media content stored on the external media source;
d) an output interface in communication with said processing unit, said output interface being operative for releasing the media signal in a format suitable for causing an output module to convey at least part of the media content associated with the external media source to a user.

33. An apparatus as defined in claim 32, wherein the certain media control command is a first media control command, in response to signals conveying a second media control command said processing unit is operative for:
i) accessing information associated to media content stored on the external media source;
ii) causing a signal conveying the information associated to media content stored on the external media source to be transmitted to the bathing unit controller through the communication entity.

34. An apparatus as defined in claim 32, wherein the output interface includes a wireless port suitable for establishing a connection with a wireless speaker module.

35. (canceled)

36. (canceled)

37. An apparatus for providing multimedia functionality for use in a bathing unit system, said apparatus comprising:
a) a body defining a cavity suitable for receiving therein an external media source storing media content;
b) an interface connector positioned within the cavity defined by the body of the apparatus and suitable for coupling with a complementary connector associated with an external media source for accessing media content stored on the external media source;
c) a communication entity operative for exchanging signals with a bathing unit controller;
d) a processing unit in communication with said interface connector and said communication entity, in use said processing unit being responsive to media control commands received from the bathing unit controller for causing a media signal to be generated, the media signal conveying at least part of the media content stored on the external media source;
e) an output interface in communication with said processing unit, said output interface being operative for releasing the media signal in a format suitable for causing an output module to convey at least part of the media content associated with the external media source to a user.

38. An apparatus as defined in claim 37, wherein the body is suitable for being positioned on an outside panel of a bathing unit

39. An apparatus as defined in claim 38, said apparatus comprising a cover member suitable for engaging the body such as to substantially enclose the cavity defined by said body.

40. An apparatus as defined in claim 39, wherein the cover member is moveably connected to the body, the cover member being movable between:
a) a first position in which it substantially encloses the cavity defined by said body; and
b) a second position in which it allows access to the cavity defined by said body.

41. An apparatus as defined in claim 39, wherein the cover member is suitable for engaging the body such as to enclose the cavity defined by said body such as to substantially prevent water from entering the cavity during use of the bathing unit system.

42. (canceled)

43. An apparatus as defined in claim 37, wherein said serial interface connector is a USB connector.

44. An apparatus as defined in claim 37, wherein said interface connector adapted for engaging an MP3 player.

45. An apparatus as defined in claim 37, said apparatus comprising a set of interface connectors positioned within the cavity defined by the body of the apparatus, the set of interface connectors including at least two connectors, the interface connectors in said set of interface connectors being suitable for engaging respective complementary connectors associated with external media sources.

46. An apparatus as defined in claim 45, wherein said set of interface connectors includes:
a) a first interface connector suitable for coupling with a complementary connector of a first type associated with a first type of external media source;
b) a second interface connector suitable for coupling with a complementary connector of a second type associated with a second type of external media source.

47. An apparatus as defined in claim 46, wherein said first interface connector is a USB connector interface and wherein said second interface connector is suitable for coupling with a complementary connector associated to an MP3 player.

48. (canceled)

49. An apparatus as defined in claim 37, wherein said processing unit is responsive to media control commands received from the bathing unit controller for:
a) accessing media content stored on the external media source over the interface connector; and
b) processing the media content to generate the media signal suitable for causing an output module to convey at least part of the media content associated with the external media source to a user.

50. (canceled)

51. (canceled)

52. An apparatus as defined in claim 37, comprising at least one positioning member positioned within the cavity defined by the body of the apparatus, the at least one positioning member being adapted for releasably engaging the external media source.

53. An apparatus as defined in claim 52, wherein said apparatus comprises two positioning members adapted for resiliently securing the external media source within the cavity defined by the body of the apparatus.

54. An apparatus as defined in claim 37, comprising a communication disconnect member adapted for causing the interface connector to acquire a state in which the external media source can be disconnected from the interface connector.

55. An apparatus as defined in claim 37, comprising a communication disconnect member, the communication disconnect member including a circuit element adapted for selectively preventing power from being communicated to the interface connector.

56. An apparatus as defined in claim 39, comprising a communication disconnect member, the communication disconnect member including a circuit element in communication with the cover member, the circuit element is operative for:
a) enabling power to be communicated to the interface connector when the cover member is engaged with the body such as to substantially enclose the cavity defined by the body;
b) preventing power to be communicated to the interface connector when the cover member is positioned such as to allow access to a user to the cavity defined by the body.

57. An apparatus as defined in claim 55, the apparatus including a visual indicator adapted for conveying to a user whether the external media source can be safely physically disconnected from the interface connector.

58-76. (canceled)
